(19) United States
(12) Patent Application Publication
(10) Pub. No.: US 2026/0269858 A1
(43) Pub. Date: Sep. 10, 2026

(54) DIGITAL TO ANALOG CONVERSION WITH DIRECT QUANTIZATION AND DECOMPOSITION INTO BANDPASS SIGNAL COMPONENTS

(71) Applicant: QDAComm LLC, Raleigh, NC (US)

(72) Inventors: Paulo Carvalho, Lisboa (PT); Rui Dinis, Costa da Caparica (PT); João Oliveira, Parede (PT)

(73) Assignee: QDAComm LLC, Raleigh, NC (US)

(21) Appl. No.: 19/072,624

(22) Filed: Mar. 6, 2025

(51) Int. Cl. H04B 1/40

(52) U.S. Cl. CPC H04B 1/40

(57) ABSTRACT

Systems and methods of performing digital to analog conversion with direct quantization and decomposition into bandpass components are presented. In one exemplary embodiment, a method is performed by a user equipment device having a set of power amplifier circuitry. The method includes amplifying, by the set of power amplifier circuitry, a set of output signals that collectively represents an amplified sample of an input signal having information. Further, the set of output signals is associated with a set of bandpass components that collectively represents a sample of the input signal. In addition, the set of bandpass components corresponds to the set of power amplifier circuitry and is associated with a quantized amplitude of a polar representation of the sample.

### FIELD OF DISCLOSURE

The present disclosure relates generally to the field of communications and more specifically to digital to analog conversion with direct quantization and decomposition into bandpass components.

### BACKGROUND

A fundamental component of a wireless communications system is the transceiver front-end which includes power amplifier circuitry. The transceiver front-end, which can include a digital baseband subsystem and an analog radio frequency (RF) subsystem, can convert digital baseband samples representing an input signal to an analog baseband signal and can then modulate the analog baseband signal and up-convert the modulated signal to a RF carrier. In this process, digital-to-analog converter (DAC) circuitry in the transceiver subsystem can convert the digital baseband samples to the analog baseband signal. In telecommunications systems, energy efficiency is a common requirement, especially in wideband communication systems employing single carrier or multicarrier modulations with high spectral efficiencies (e.g., large constellations), in which envelope fluctuations can compromise power amplification efficiency by a power amplifier in the transceiver front end. The Background section of this document is provided to place embodiments of the present disclosure in technological and operational context, to assist those of skill in the art in understanding their scope and utility. Unless explicitly identified as such, no statement herein is admitted to be prior art merely by its inclusion in the Background section.

### BRIEF SUMMARY OF THE DISCLOSURE

The following presents a simplified summary of the disclosure in order to provide a basic understanding to those of skill in the art. This summary is not an extensive overview of the disclosure and is not intended to identify key/critical elements of embodiments of the disclosure or to delineate the scope of the disclosure. The sole purpose of this summary is to present some concepts disclosed herein in a simplified form as a prelude to the more detailed description that is presented later.

Briefly described, embodiments of the present disclosure relate to systems and methods of performing quantized amplification by a set of power amplifiers. According to one aspect, a method can include receiving the samples of a baseband signal or the samples of in-phase and quadrature-phase (I/Q) components of a baseband signal, receiving an input clock signal according to the sampling frequency fₛ=1/Ts of the baseband signal, receiving a clock signal according to an intermediate frequency fᵢ, or receiving a clock signal in accordance with the carrier frequency f_{c} of the RF output signal. The method can include determining the corresponding bandpass format of the baseband samples s_{BBn}=s_{BBn}(tₙ)=s_{l,n}+j s_{Q,n}=Aₙ cos (αₙ)+jAₙ sin (αₙ)=Aₙ exp (j αₙ), by computing amplitude

$${A}_{n} = \sqrt{{s}_{I , n}^{2} + {s}_{Q , n}^{2}} , {α}_{n} = {tan}^{- 1} ( {s}_{Q , n} / {s}_{I , n} ) ,$$

and RF sampling time difference Δt_{c}=mod (Δt+nT_{S},T_{c}), where T_{c}=1/fᵢ, and intermediate frequency (IF) sampling time difference Δtᵢ=mod (Δt+nT_{S},Tᵢ) where Tᵢ=1/fᵢ. The method can include quantizing, by a quantizer circuit, the amplitude Aₙ to obtain a quantized amplitude A_{qn}=Aₙ+e_{q} represented by N_{bq} quantization bits, where e_{q} denotes the quantization error of the quantized amplitude A_{qn}, and determining the quantization error e_{q} of the quantized amplitude A_{qn} as the difference between Aₙ and A_{qn}. The method can include receiving, by a mapper circuit, the quantization error e_{q}, the phase αₙ, the quantized amplitude A_{qn} represented by the N_{bq} quantization bits and the quantized quantization error e_{qQ} to determine a set of N′≤N_{bq} active pairs of in-phase and quadrature-phase mapping components having amplitudes aᵢ in which the quantized value A_{qn} can be decomposed, according to a mapping table that contains the N_{bq} quantization bits combinations, the sets of discrete amplitudes aᵢ and the set of quantized values. The method can include determining, by the mapper circuitry having the set of amplitudes aᵢ={a₁, a₂, . . . , a_{N}_{_{bq}}}, a set of coefficients C_{i,n} needed to map the quantized amplitude A_{qn} into N′ pairs of in-phase s_{1,i} and quadrature-phase s_{Q,i} mapping components given by C_{i,n}aᵢ cos (αₙ) and C_{i,n}aᵢ sin (αₙ), that when combined correspond to the quantized sample of the input signal represented by

$${S}_{BBnq} = {\sum }_{i = 1}^{{N}_{b q}} {C}_{i , n} {a}_{i} cos ( {α}_{n} ) + j {\sum }_{i = 1}^{{N}_{b q}} {C}_{i , n} {a}_{i} sin ( {α}_{n} ) = {\sum }_{i = 1}^{{N}_{b q}} {s}_{I , i} + {js}_{Q , i} .$$

The set of amplitudes aᵢ can be expressed in terms of the quantization components {s_{I,1}, s_{Q,1}; s_{I,2}, s_{Q,2}; . . . ; s_{l,N}_{_{bq}}, s_{Q,N}_{_{bq}}} by {a₁=\sqrt{s_{l,1}²+s_{Q,1}²}; a₂=\sqrt{s_{l,2}²+s_{Q,2}²}; . . . ; a_{N}_{_{bq}}={square root over (s_{l,N}_{_{bq}}²+s_{Q,N}_{_{bq}}²)}}. The method can include sending, by the mapper circuit, to a set of I/Q modulator circuits, each pair of in-phase and quadrature components and the phase αₙ. The method can include generating, by the set of I/Q modulator circuits, for the sampling interval Δt+nT_{S}≤tₛ≤Δt+(n+1)T_{S}, a set of RF bandpass components given by S_{BP}_{_{n,i}}=S_{BP}(tₛ)=C_{i,n}aᵢ cos (2πf_{c}tₛ+αₙ). The method can include summing the set of RF bandpass components to obtain the signal

$${S}_{B P n} = {\sum }_{i = 1}^{{N}_{b q}} {S}_{B P n , i} = ( {\sum }_{i = 1}^{{N}_{b q}} {C}_{i , n} {a}_{i} ) cos ( 2 π {f}_{c} {t}_{s} + {α}_{n} ) = ( {\sum }_{i = 1}^{{N}_{b q}} {C}_{i , n} {a}_{i} ) cos ( {α}_{n} ) cos ( 2 π {f}_{c} {t}_{s} ) - ( {\sum }_{i = 1}^{{N}_{b q}} {C}_{i , n} {a}_{i} ) sin ( {α}_{n} ) sin ( 2 π {f}_{c} {t}_{s} ) .$$

According to one aspect, an electronic device can be operable to receive samples of a baseband signal or samples of in-phase and quadrature-phase components of a baseband signal, receive an input clock signal according to the sampling frequency fₛ=1/T_{S} of the baseband signal, receive a clock signal according to an intermediate frequency fᵢ, or receive a clock signal in accordance with the carrier frequency f_{c} of the RF output signal. The electronic device can be further operable to determine the corresponding bandpass format of the baseband samples s_{BBn}=s_{BBn}(tₙ)=s_{l,n}+j s_{Q,n}=Aₙ cos (αₙ)+jAₙ sin (αₙ)=Aₙ exp (j αₙ), by computing amplitude

$${A}_{n} = \sqrt{{s}_{I , n}^{2} + {s}_{Q , n}^{2}} , {α}_{n} = {tan}^{- 1} ( {s}_{Q , n} / {s}_{I , n} ) ,$$

and Δt_{c}=mod (Δt+nT_{S},T_{c}), where T_{c}=1/f_{c}, and Δtᵢ=mod (Δt+nT_{S},Tᵢ) where Tᵢ=1/fᵢ. The electronic device can be further operable to quantize, by a quantizer circuit, the amplitude Aₙ to obtain a quantized amplitude A_{qn}=Aₙ+e_{q} represented by N_{bq} quantization bits, where e_{q} denotes the quantization error of the quantized amplitude A_{qn}, and determining the quantization error e_{q} of the quantized amplitude A_{qn} as the difference between Aₙ and A_{qn}. The electronic device can be further operable to receive, by a mapper circuit, the quantization error e_{q}, the phase αₙ, the quantized amplitude A_{qn} represented by the N_{bq} quantization bits and the quantized quantization error e_{qQ} to determine a set of N′≤N_{bq} active pairs of in-phase and quadrature-phase mapping components having amplitudes aᵢ in which the quantized value A_{qn} can be decomposed, according to a mapping table that contains the N_{bq} quantization bits combinations, the sets of discrete amplitudes aᵢ and the set of quantized values. The electronic device can be further operable to determine, by the mapper circuitry having the set of amplitudes aᵢ={a₁, a₂, . . . , a_{N}_{_{bq}}}, a set of coefficients C_{i,n} needed to map the quantized amplitude A_{qn} into N′ pairs of in-phase s_{I,i} and quadrature-phase s_{Q,i} mapping components given by C_{i,n}aᵢ cos (αₙ) and C_{i,n}aᵢ sin (aₙ), that when combined correspond to the quantized sample of the input signal represented by

$${S}_{B B n q} = {\sum }_{i = 1}^{{N}_{b q}} {C}_{i , n} {a}_{i} cos ( {α}_{n} ) + j {\sum }_{i = 1}^{{N}_{b q}} {C}_{i , n} {a}_{i} sin ( {α}_{n} ) = {\sum }_{i = 1}^{{N}_{b q}} {s}_{I , i} + {js}_{Q , i} .$$

The set of amplitudes aᵢ can be expressed in terms of the quantization components {s_{l,1}, s_{Q,1}; s_{l,2}, s_{Q,2}; . . . ; s_{l,N}_{_{bq}}, s_{Q,N}_{_{bq}}} by {a₁=\sqrt{s_{l,1}²+s_{Q,1}²}; a₂=\sqrt{s_{l,2}²+s_{Q,2}²}; . . . ; a_{N}_{_{bq}}={square root over (s_{l,N}_{_{bq}}²+s_{Q,N}_{_{bq}}²)}}. The electronic device can be further operable to send, by the mapper circuit, to a set of I/Q modulator circuits, each pair of in-phase and quadrature components and the phase αₙ. The electronic device can be further operable to generate, by the set of I/Q modulator circuits, for the sampling interval Δt+nT_{S}≤tₛ≤Δt+(n+1)T_{S}, a set of RF bandpass components given by S_{BPn,i}=S_{BP}(tₛ)=C_{i,n}aᵢ cos (2πf_{c}tₛ+αₙ). The electronic device can be further operable to sum the set of RF bandpass components to obtain the signal

$${S}_{B P n} = {\sum }_{i = 1}^{{N}_{b q}} {S}_{B P n , i} = ( {\sum }_{i = 1}^{{N}_{b q}} {C}_{i , n} {a}_{i} ) cos ( 2 π {f}_{c} {t}_{s} + {α}_{n} ) = ( {\sum }_{i = 1}^{{N}_{b q}} {C}_{i , n} {a}_{i} ) cos ( {α}_{n} ) cos ( 2 π {f}_{c} {t}_{s} ) - ( {\sum }_{i = 1}^{{N}_{b q}} {C}_{i , n} {a}_{i} ) sin ( {α}_{n} ) sin ( 2 π {f}_{c} {t}_{s} ) .$$

According to another aspect, the electronic device can be further operable to send, by the mapper circuit, to the set of I/Q modulator circuits, the amplitudes aᵢ and the phase αₙ of each sample to control the initial phase of bandpass components generated by the set of I/Q modulators or I/Q DACs, which can be performed by changing the phases or delays of the inputs of the I/Q modulator circuits or I/Q DACs at the beginning of each sampling interval.

According to another aspect, the electronic device can be further operable to receive, by the mapper circuit, a quantized quantization error e_{qQ} that is weighted and added to the discrete amplitudes aᵢ of active pairs of mapping components.

According to another embodiment, the electronic device can be further operable to receive, by the mapper circuit, a quantized quantization error e_{qQ} that is only added to the smaller or smallest mapping component or is only added to the higher or highest mapping component or is only added to at least one arbitrary active quantization component.

According to another aspect, the electronic device can be further operable to generate, by the set of I/Q modulator circuits, the set of IF bandpass quantization components having an intermediate frequency (IF) fᵢ. Further, the electronic device can be further operable to up-convert, by a mixer circuit, the set of IF bandpass quantization components to obtain a set of RF bandpass components having the RF carrier frequency f_{c}.

According to another aspect, the electronic device can be further operable to process each one of active pairs of in-phase and quadrature-phase quantization components in one of a set of quadrature modulator circuits to generate a set of N′ active IF bandpass components. The electronic device can be further operable to up-convert, by a set of N′ mixer circuits, the set of N′ active IF bandpass components to obtain a set of N′ RF bandpass components.

According to another aspect, the electronic device can be further operable to determine, by an analog or digital circuit, amplitude

$${A}_{n} = \sqrt{{s}_{I , n}^{2} + {s}_{Q , n}^{2}} ,$$

phase αₙ=tan⁻¹(s_{Q,n}/s_{l,n}), RF sampling time difference Δt_{c}=mod (Δt+nT_{S},T_{c}) and IF sampling time difference Δtᵢ=mod (Δt+nT_{S},Tᵢ), quantizes Aₙ, maps the quantization bits into components, adds the quantization error, or generates the activate quantization components.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete and will fully convey the scope of the disclosure to those skilled in the art. Like numbers refer to like elements throughout.

FIG. 1 illustrates one embodiment of a method of performing baseband digital to analog conversion with direct quantization and decomposition into bandpass components in accordance with various aspects as described herein.

FIG. 2 illustrates one embodiment of a system of performing baseband digital to analog conversion with direct quantization and decomposition into bandpass components using quadrature-phase modulators in accordance with various aspects as described herein.

FIG. 3 illustrates one embodiment of a system of performing baseband digital to analog conversion with direct quantization and decomposition into bandpass components using DACs in accordance with various aspects as described herein.

FIG. 4 illustrates one embodiment of a wireless communication network in accordance with various aspects as described herein.

FIG. 5 illustrates one embodiment of an electronic device in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

In the current disclosure, systems and methods of digital to analog conversion with direct quantization and decomposition into bandpass components are presented. In one exemplary embodiment, modulated bandpass signals can be described for each symbol interval T by s_{BP}(t)=s_{I}(t) cos (ω_{c}t)−s_{Q}(t) sin (ω_{c}t), where ω_{c}=2πf_{c} denotes the angular frequency, f_{c} denotes the carrier frequency, and sₗ(t) and s_{Q}(t) denote the in-phase and the quadrature-phase component, respectively. This signal can also be described in terms of its complex envelope or baseband representation by s_{BP}(t)=Re{\tilde{s}_{BB}(t)e^{jω}^{_{c}}^{t}}, where \tilde{s}_{BB}(t)=sₗ(t)+j_{S}_{_{Q}}(t) denotes the complex envelope of the baseband signal s_{BB}(t), with the envelope given by A(t)={square root over ((sₗ(t)²+(s_{Q}(t))²)} and the phase given by α(t)=a tan (s_{Q}(t)/sₗ(t)), where a tan (·) denotes the arc tangent function. When these signals are sampled with a sampling rate fₛ=1/Tₛ and at a sampling instant tₙ=nTₛ can result in a sample s_{BBn}=s_{BB} (tₙ)=s_{l,n}+j s_{Q,n}=Aₙ cos (αₙ)+j Aₙ sin (αₙ)=Aₙ exp (j αₙ), where s_{l,n}=Aₙ cos (αₙ), s_{Q,n}=Aₙ sin (αₙ),

$${A}_{n} = \sqrt{{s}_{I , n}^{2} + {s}_{Q , n}^{2}}$$

and αₙ=a tan (s_{Q,n}/s_{l,n}). The sample of the corresponding bandpass signal can be s_{B}_{ₚₙ}=s(tₙ)=sₗ(tₙ) cos (2πf_{c}tₙ)−s_{Q}(tₙ) sin (2πf_{c}tₙ) and for a bandpass signal at an intermediate frequency f_{c} results in the sample sₙ=s(tₙ)=sₗ(tₙ) cos (2πfᵢtₙ)−s_{Q}(tₙ) sin (2πfᵢtₙ), where fᵢ denotes the intermediate frequency. A baseband signals can be single carrier signal or a multi-carrier signal like orthogonal frequency division multiplexing (OFDM). A baseband continuous time OFDM signal can be given by

$${s}_{m} ( t ) = {\sum }_{K = 1}^{N} {S}_{k , m} {e}^{j 2 π k F t} ,$$

−T_{G}≤t≤T, where j at the exponential term is the imaginary unit, N is the set of subcarriers in total, s_{k,m} is the data symbol which is transmitted at the k^{th} subcarrier of the m^{th} OFDM data symbol, F=1/T, with T the useful data duration, T_{G} is the cyclic prefix duration, and the total OFDM symbol block duration is T_{SB}=T+T_{G}. The transmitted baseband total signal can be written as s_{BB}(t)=Σₘsₘ (t−mT_{S}). The corresponding bandpass signal can be s_{BP}(t)=Re{s_{BB}(t)e^{jω}^{_{c}}^{t}}, with w_{c}=2πf_{c}. For an OFDM signal having a large number of subcarriers, sₘ(t) can be given as sₘ(t)=sₗ+js_{Q}=A(t)e^{jα(t)}, where

$$A ( t ) = \sqrt{{( {s}_{I} ( t ) )}^{2} + {( {s}_{Q} ( t ) )}^{2}} and α ( t ) = atan ( \frac{{s}_{Q} ( t )}{{s}_{I} ( t )} ) .$$

For the sampling instant tₙ=nTₛ=1/fₛ results for the baseband signal the sample s_{BBn}=s_{BB}(tₙ)=s_{l,n}+s_{Q,n}=Aₙ cos (αₙ)+j Aₙ sin (αₙ)=Aₙ exp (j αₙ). This means that single carrier and multiple carrier signals can be decomposed as a sum of bandpass mapping components, through a quantization process of the samples followed by a mapping of the quantized value into a set of bandpass mapping components with discrete amplitudes.

In the current embodiment, the quantization bits of the quantized amplitude Aₙ of each sample at the sampling instant to can be mapped into a set of pairs of in-phase and quadrature-phase mapping components having fixed amplitudes aᵢ that can be expressed in terms of in-phase and quadrature-phase quantization components {s_{l,1}, s_{Q,1}; s_{l,2}, s_{Q,2}; . . . ; s_{l,N}_{_{bq}}, s_{Q,N}_{_{bq}}} {s_{l,1}, s_{Q,1}; s_{l,2}, s_{Q,2}; . . . ; s_{l,N}_{_{bq}}, s_{Q2,N}_{_{bq}}}. The phase αₙ of each sample can be applied to control the initial phase of the sinusoidal signals generated by a set of I/Q modulators or I/Q DACs for each sampling interval, which can be performed by changing the phases or delays of the inputs of the I/Q modulators or I/Q DACs. A quantization and mapping digital process can compute in advance the mapping components and the quantization error e_{q} given by the difference between the computed envelope value and the corresponding quantized envelope value. To reduce quantization error noise, the quantization error e_{q} or a quantized quantization error e_{qQ}, can be incorporated into the amplitudes of one or more bandpass mapping components to reduce the error associated with the process. A set of I/Q modulators or I/Q DACs operating in parallel can generate a set of bandpass components at a carrier frequency f_{c}. The digital to analog conversion can be a process having a quantizer and a mapper followed by I/Q DACs. To reduce impact on the noise floor, digital compensation of the quantization error e_{q} of the quantizer can be performed to reduce the quantization noise towards the quantization noise floor associated with the resolution of the DACs.

In another embodiment, a system can receive samples of a baseband signal or samples of in-phase and quadrature-phase components of a baseband signal and can receive a clock signal associated with a sampling frequency fₛ=1/T_{S} of the baseband signal, a clock signal associated with an intermediate frequency fᵢ, a clock signal associated with a carrier frequency f_{c} of an RF output signal, or the like. The system can also represent a prior computation of the corresponding bandpass format of the baseband samples s_{BBn}=s_{BB}(tₙ)=s_{l,n}+j s_{Q,n}=Aₙ cos (αₙ)+jAₙ sin (αₙ)=Aₙ exp (j αₙ), by computing

$${A}_{n} = \sqrt{{s}_{I , n}^{2} + {s}_{Q , n}^{2}} ,$$

αₙ=a tan (s_{Q,n}/s_{l,n}), and Δt_{c}=mod (Δt+nT_{S},T_{c}), where T_{c}=1/f_{c}, and Δtᵢ=mod (Δt+nT_{S},Tᵢ), where Tᵢ=1/fᵢ, and passing them to a quantizer. A quantizer, with N_{bq} quantization bits, based on the prior computed value of an amplitude Aₙ, can generate a quantized amplitude A_{qn}=Aₙ+e_{q}, where e_{q} denotes the quantization amplitude error, and can compute the quantization amplitude error e_{q}. A mapper can receive the quantized amplitude Aₙ, the computed phase αₙ, the set of N_{bq} quantization bits that represent the quantized amplitude A_{qn}, the quantized quantization amplitude error e_{q}, or the like to generate an active set of N′≤N_{bq} pairs of in-phase and quadrature-phase mapping components having amplitudes aᵢ in which the quantized value A_{qn} can be decomposed, according to a mapping table that contains the quantization bits combinations, the sets of discrete amplitudes aᵢ, the set of quantized values, or the like. The mapper, based on the set of amplitudes aᵢ={a₁, a₂, . . . , a_{N}_{_{bq}}}, can also computes a set of coefficients C_{i,n} to map the quantized value into a set of N′ pairs of in-phase s_{l,i} and quadrature-phase s_{Q,i} mapping components given by C_{i,n}aᵢ cos (αₙ) and C_{i,n}aᵢ sin (αₙ), when combined correspond to the quantized representation of the sample of the input signal given by

$${S}_{BBnq} = {\sum }_{i = 1}^{Nbq} {C}_{i , n} {a}_{i} cos ( {α}_{n} ) + j {\sum }_{i = 1}^{Nbq} {C}_{i , n} {a}_{i} sin ( {α}_{n} ) = {\sum }_{i = 1}^{Nbq} {s}_{I , i} + {js}_{Q , i} .$$

The set of amplitudes aᵢ can be expressed in terms of the quantization components {s_{l,1}, s_{Q,1}; s_{l,2}, s_{Q,2}; . . . ; s_{l,N}_{_{bq}}, s_{Q,N}_{_{bq}}} by {a₁=\sqrt{s_{l,1}²+s_{Q,1}²}; a₂=\sqrt{s_{l,2}²++s_{Q,2}²}; . . . ; N_{bq}={square root over (s_{l,N}_{_{bq}}²+s_{Q,N}_{_{bq}}²)}}. The mapper can provide each pair of in-phase and quadrature-phase components and the phase αₙ to an I/Q modulator to generate, for the sampling interval Δt+nT_{S}≤tₛ≤Δt+(n+1)T_{S}, a set of bandpass components at an RF carrier frequency f_{c} given by S_{BPn,i}=S_{BP}(tₛ)=C_{i,n}aᵢ cos (2πf_{c}tₛ+αₙ). The set of bandpass components when summed can generate the signal

$${S}_{BPn} = {\sum }_{i = 1}^{Nbq} {S}_{BPn , i} = ( {\sum }_{i = 1}^{Nbq} {C}_{i , n} {a}_{i} ) cos ( 2 π {f}_{c} {t}_{s} + {α}_{n} ) = ( {\sum }_{i = 1}^{Nbq} {C}_{i , n} {a}_{i} ) cos ( {α}_{n} ) cos ( 2 π {f}_{c} {t}_{s} ) - ( {\sum }_{i = 1}^{Nbq} {C}_{i , n} {a}_{i} ) sin ( {α}_{n} ) sin ( 2 π {f}_{c} {t}_{s} ) .$$

In another embodiment, the mapper can provide the amplitudes aᵢ and the phase αₙ of each sample to control the initial phase of the set of bandpass components generated by the set of I/Q modulators or I/Q DACs, which can be done by changing the phases or delays of the inputs of the I/Q modulators or I/Q DACs at the beginning of each sampling interval.

In another embodiment, the mapper can receive a quantized quantization error e_{qQ} that is weighted added to the discrete amplitudes aᵢ of the active set of pairs of mapping components.

In another embodiment, the quantized quantization error e_{qQ} can be added to any of the active set of quantization components. For example, the quantized quantization error e_{qQ} can be added to the smallest mapping component. In another example, the quantized quantization error e_{qQ} can be added to the largest mapping component. In yet another example, the quantized quantization error e_{qQ} can be added to one arbitrary active quantization component.

In another embodiment, each I/Q modulator can generate each bandpass quantization component at an intermediate frequency fᵢ. Further, a set of mixers can up-convert the set of bandpass components to the carrier frequency f_{c}.

In another embodiment, the method and apparatus of performing baseband digital to analog conversion with direct quantization and decomposition into bandpass components can include processing each of the active set of pairs of in-phase and quadrature-phase quantization components by a quadrature-phase modulator to generate an active set of N′ bandpass components at an intermediate frequency fᵢ that are submitted to a set of N′ mixers to up-convert and generate an active set of N′ bandpass components at an RF carrier frequency f_{c}.

In another embodiment, the method and apparatus of performing baseband digital to analog conversion with direct quantization and decomposition into bandpass components can include a digital block that computes the amplitude

$${A}_{n} = \sqrt{{s}_{I , n}^{2} + {s}_{Q , n}^{2}} , {α}_{n} = a tan ( {s}_{Q , n} / {s}_{I , n} ) ,$$

Δt_{c}=mod (Δt+nT_{S},T_{c}) and Δtᵢ=mod (Δt+nT_{S},Tᵢ), quantizes the amplitude Aₙ, maps the quantization bits into components, adds the quantization error, and generates the activate quantization components.

In one embodiment, a baseband input signal can be converted with a direct quantization and decomposition into analog bandpass components, based on a prior computation of the corresponding bandpass format of the baseband samples to perform a direct mapping into bandpass quantization components using a unique quantizer followed by a mapper.

In another embodiment, a system can receive one baseband signal which is sampled to generate the samples that are converted posteriorly into the set of bandpass components.

In another embodiment, a system can receive the samples sₗₙ and s_{Qn} of the in-phase and quadrature-phase components of a baseband signal.

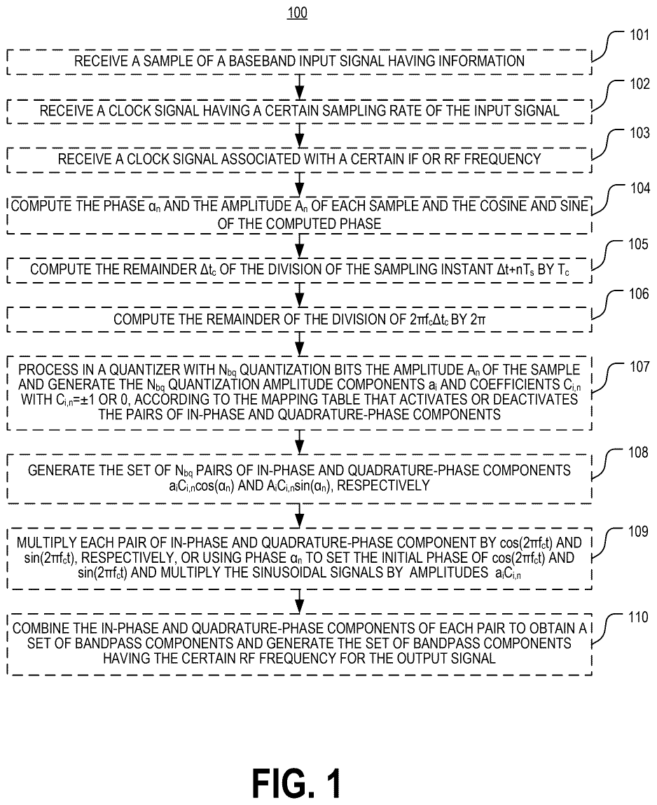

FIG. 1 illustrates one embodiment of a method 100 of performing baseband digital to analog conversion with direct quantization and decomposition into bandpass components in accordance with various aspects as described herein. In FIG. 1, the method 100 may start, for instance, at block 101 where it can include receiving a sample of a baseband input signal having information. In another embodiment, the method 100 can include receiving a baseband signal and sampling, a sampling circuitry or a sample and hold (S/H) circuit, to obtain the samples of the baseband input signal. In another embodiment, the method 100 can include receiving samples of in-phase and quadrature-phase components of a baseband signal. At block 102, the method 100 can include receiving a clock signal having a certain sampling rate of the input signal. A skilled artisan will readily recognize that the sample rate may vary according to the bandwidth of the input signal and the desired time resolution of the sampling process. At block 103, the method 100 can include receiving a clock signal associated with an IF frequency fᵢ or RF frequency f_{c}. In another embodiment, the method 100 can include receiving a clock signal associated with the bandwidth of the input signal. In another embodiment, the method 100 can include receiving a clock signal having a certain intermediate frequency fᵢ, with that intermediate frequency being greater than at least the bandwidth of the input signal. At block 104, the method 100 can include computing the phase αₙ and the amplitude Aₙ of each sample and the cosine and sine of the computed phase. At block 105, the method 100 can include determining the remainder Δt_{c} of the division of the sampling instant Δt+nT_{S} by Tc=1/f_{c} and the remainder Δtᵢ of the division of the sampling instant Δt+nT_{S} by Tᵢ=1/fᵢ. At block 106, the method 100 can include processing in a quantizer circuitry with N_{bq} quantization bits the amplitude Aₙ of the sample and generating the N_{bq} quantization amplitude components a₁ and coefficients C_{i,n} with C_{i,n}=±1 or 0, according to the mapping table configured to activate or deactivate the pairs of in-phase and quadrature-phase mapping components. At block 107, the method 100 can include processing in a quantizer with N_{bq} quantization bits the amplitude Aₙ of the sample and generating the N_{bq} quantization amplitude components a₁ and coefficients C_{i,n} with C_{i,n}=±1 or 0, according to the mapping table configured to activate or deactivate the pairs of in-phase and quadrature-phase components. At block 108, the method 100 can include generating the N_{bq} in-phase and quadrature-phase components a₁C_{i,n} cos (αₙ) and AᵢC_{i,n} sin (αₙ), respectively. At block 109, the method 100 can include multiplying each in-phase and quadrature-phase component by cos (2πf_{c}t) and sin (2πf_{c}t), respectively, or using phase αₙ to set the initial phase of cos (2πf_{c}t) and sin (2πf_{c}t) and multiplying the sinusoidal signals by amplitudes aᵢC_{i,n}. At block 110, the method 100 can include adding the in-phase and quadrature-phase components of each quantization component to obtain a set of bandpass components and generating the set of bandpass components at an RF carrier frequency f_{c} for the output signal.

In another embodiment, the method 100 can include determining the remainder Δtᵢ of the division of the sampling instant Δt+nT_{S} by Tᵢ=1/fᵢ, and determining the remainder of the division of 2πfᵢΔtᵢ by 2π to obtain an initial phase θᵢ for each sampling interval.

In another embodiment, the method 100 can include determining the remainder Δt_{c} of the division of the sampling instant Δt+nT_{S} by T_{c}=1/f_{c}, and determining the remainder of the division of 2πfᵢΔt_{c} by 2π, to obtain an initial phase θᵢ for each sampling interval.

In another embodiment, a single circuitry can be configured to determine the quantization error e_{q} and quantize the quantization error e_{q} to obtain the quantized quantization error e_{qQ}, which can be added to the amplitudes aᵢ of one or more active mapping components.

In another embodiment, the functions of block 105, 106 and 107 can be performed by a single circuitry using a comparator circuitry and a look-up table (LUT) having the corresponding discrete values of the amplitudes or phases of the digital control signals that active or deactivate the pairs of signal components.

In another embodiment, the method 100 can include multiplying each in-phase and quadrature-phase components by cos (2πfᵢt) and sin (2πfᵢt), respectively, and adding the in phase and quadrature-phase components, to obtain the corresponding set of bandpass components at a certain intermediate frequency. This method step can be repeated for each sampling time instant associated with the successive time samples of the input baseband signal.

In another embodiment, successive samples of the input signal can be processed to determine the set of phases an and amplitudes Aₙ, prior to quantizing those samples.

In another embodiment, the quadrature-phase modulator circuitry operable to quadrature modulate each pair of quantization components can be replaced by an I/Q DAC circuitry for direct up-conversation or by an I/Q DAC circuitry coupled to a mixer circuit.

In another embodiment, a single circuitry can be configured to perform the quantizing, mapping and generating steps to obtain the bandpass components.

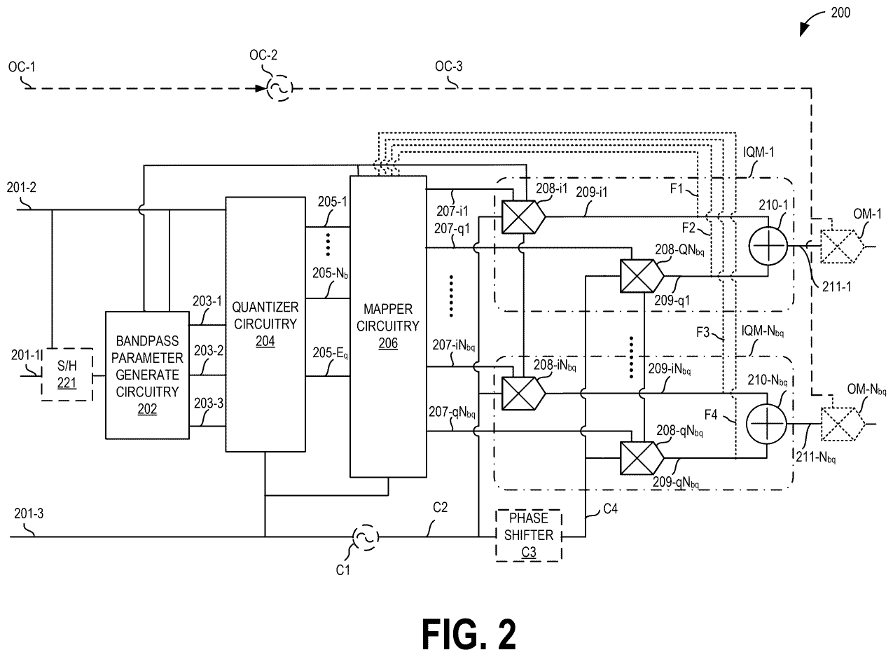

FIG. 2 illustrates one embodiment of a system 200 of performing baseband digital to analog conversion with direct quantization and decomposition into bandpass components using quadrature-phase modulators in accordance with various aspects as described herein. In FIG. 2, the system 200 can be operable to receive input signal 201-1 having time samples s_{BBn} of a baseband signal. In one example, the system 200 can be operable to receive the input signal 201-1 having samples sₗₙ and s_{Qn} of the in-phase and quadrature-phase components of a baseband signal. The system 200 can further be operable to receive input signal 201-2 having a baseband signal s_{BB}(t) which is sampled by sampling circuitry or sample and hold circuitry 221, to generate the time samples s_{BBn}=s_{BB}(tₙ). The system 200 can further be operable to receive clock reference signal 201-2 having a sampling frequency fₛ and a reference clock signal 201-3 having an RF carrier frequency f_{c}. In another example, the system 200 can receive the reference clock signal 201-3 having the intermediate frequency fᵢ and the clock signal OC-1 having the desired RF carrier frequency f_{c}. A skilled artisan will recognize that the selection of the clock reference signals can be made according to the bandwidth of the input signal, the desired frequency for the output signal, or the like. The clock signal 201-2 can be configured as a clock reference signal having a sampling frequency and can be input to the sampling circuitry or sample and hold circuitry 221 operable to sample the input signal 201-1, a bandpass parameter generate circuitry 202 operable to computes the phase αₙ and the amplitude Aₙ of each sample, a quantizer circuitry 204 operable to quantize the amplitude Aₙ of each sample, a mapper circuitry 205 operable to generate the mapping components, a set of I/Q modulator circuitry IQM−{1, . . . ,N_{bq}} operable to modulate the mapping components, or the like.

In FIG. 2, the bandpass parameters computation block 202 can be operable to receive the samples of s_{BBn} of s_{BB} (t), compute the amplitude

$${A}_{n} = \sqrt{{s}_{I , n}^{2} + {s}_{Q , n}^{2}} ,$$

αₙ=a tan (s_{Q,n}/s_{l,n}), Δt_{c}=mod (Δt+nT_{S},T_{c}) and Δtᵢ=mod (Δt+nTS,Ti). The quantizer circuitry 204 can receive, from the computation block 202, the amplitude Aₙ 203-1 and the phase αₙ 203-2 of each sample, and the values Δtc or Δti can be input to the quantizer circuitry 204 through signal 203-3. The quantizer circuitry 204 can be operable to quantize the amplitude Aₙ of each sample 203-1 based on the clock signal 201-2, generate the quantized amplitude A_{qn}=Aₙ+e_{q} and the set of quantization amplitude bits 205-{1, . . . ,N_{bq}}, compute the quantization amplitude error e_{q} as the difference between the amplitude Anand the quantized amplitude A_{qn} and the coefficients

$${C}_{i , n} = \{ \begin{matrix}\pm 1 \\ 0\end{matrix}$$

needed to represent the quantized amplitude in terms of the set aᵢ={a₁, a₂, . . . , a_{Nbq}} of discrete amplitudes in which the quantized value can be decomposed. The quantizer circuitry 204 can also be operable to quantize the quantization amplitude error e_{q} into the quantized quantization amplitude error e_{qQ} based on a LUT circuitry having values representing N_{qe} quantization intervals with

$${N}_{q e} \leq {2}^{{N}_{bq}} .$$

In another embodiment, the quantizer circuitry 204 can be operable to generate a weighted sum of quantized quantization amplitude error e_{qQ} to the amplitudes aᵢ of the active quantization components.

In FIG. 2, the mapper circuitry 206 can be operable to receive the set of quantization bits 205-{1, . . . ,N_{bq}}, the quantized quantization error e_{qQ} 205-Eq, or the like and generate an active set of N′≤N_{bq} pairs of in-phase and quadrature-phase quantization components based on a mapping table that can be stored in a LUT circuitry configured to include the quantization amplitude bit combinations, the sets of discrete amplitudes aᵢ, the set of quantized amplitude values, or the like. The mapper circuitry 206 can be further operable, based on a mapping table having quantization bits and the set of amplitudes aᵢ={a₁, a₂, . . . , a_{N}_{_{bq}}}, to compute the coefficients C_{i,n} to map the quantized value into an active set of N′≤N_{bq} pairs of in-phase s_{I,i} and quadrature-phase s_{Q,i} mapping components 207−{i1, . . . ,iN_{bq}}, 207−{q1, . . . ,qN_{bq}}, given by C_{i,n}aᵢ cos (αn) and C_{i,n}aᵢ sin (αn) with i={1, . . . ,N_{bq}}, that when the each pair is combined corresponds to the quantized representation of the sampled input signal given by

$${S}_{B B n q} = {\sum }_{i = 1}^{N b q} {C}_{i , n} {a}_{i} cos ( α n ) + j {\sum }_{i = 1}^{N b q} {C}_{i , n} {a}_{i} sin ( α n ) = {\sum }_{i = 1}^{N b q} {s}_{I , i} + j {s}_{Q , i} .$$

The mapper circuitry 206 can be operable to output the active set of N′≤N_{bq} pairs of in-phase and quadrature-phase mapping components 207−{i1, . . . ,iN_{bq}}, 207−{q1, . . . ,qN_{bq}} to a set of N_{bq} I/Q modulator circuitry IQM-{1, . . . ,N_{bq}} operable to generate the active set of N′≤N_{bq} bandpass components 211−{1, . . . ,N_{bq}}, each bandpass component over the sampling interval Δt+nT_{S}≤tₛ≤Δt+(n+1)T_{S} given by S_{BPn,i}=S_{BP}(tₛ)=C_{i,n}aᵢ cos (2πf_{c}tₛ+αₙ).

In FIG. 2, a local oscillator circuitry C1 can be operable to generate a cosine signal C2 having the frequency given of the reference signal 201-3, to be input to the set of mixer circuitry 208−{i₁, . . . ,i_{Nbq}}. A phase shifter circuitry C3 can be operable to generate a sine signal C4 for input to the set of mixer circuitry 208−{q₁, . . . ,q_{Nbq}}. The set of mixer circuitry 208−{i₁, . . . ,i_{Nbq}}, 208−{q₁, . . . ,q_{Nbq}} can be operable to mix or multiply in-phase and quadrature-phase mapping components 207−{i₁, . . . ,i_{Nbq}}, 207−{q₁, . . . ,q_{Nbq}} by the signals C2 and C4, respectively. A set of adder or summation circuitry 210−{1, . . . ,N_{bq}} can be operable to sum each pair of in-phase and quadrature-phase components 209−{i₁, . . . ,i_{Nbq}} and 209−{q₁, . . . ,q_{Nbq}} to generate a set of corresponding bandpass components 211−{1, . . . ,N_{bq}}, which when summed generate the signal

$${S}_{B P n} = {\sum }_{i = 1}^{N b q} {S}_{B P n , i} = ( {\sum }_{i = 1}^{N b q} {C}_{i , n} {a}_{i} ) cos ( 2 π {f}_{c} {t}_{s} + {α}_{n} ) ,$$

which is a quantized representation of the bandpass signal.

In another embodiment, the mapper circuitry 206 can be operable to output the amplitudes aᵢ and the phase αₙ of each sample to a set of I/Q modulator circuitry or a set of I/Q DAC circuitry to control the initial phase of the sinusoidal signals generated by the set of I/Q modulator circuitry or the set of I/Q DAC circuitry for each sampling interval.

In another embodiment, the set of N_{bq} I/Q modulator circuitry can be operable to generate the active set of bandpass components at the intermediate frequency fᵢ and a set of N_{bq} mixer circuitry can be operable to up-convert the active set of N′≤N_{bq} bandpass components to the carrier RF frequency f_{c}.

In another embodiment, the mapper circuitry 206 can be operable to receive the quantized quantization amplitude error e_{qQ} 205-E_{q} that is weighted added to the discrete amplitudes aᵢ of active set of pairs of mapping components.

In another embodiment, the quantized quantization amplitude error e_{qQ}205-E_{q} can be added to a smallest mapping component, can be added to the largest mapping component, can be added to one arbitrary active mapping component, or the like.

In another embodiment, the mapper circuitry 206 can be operable to receive, from the bandpass parameter generate circuitry 202, the amplitude Aₙ 203-1 and the phase αₙ 203-2 of each sample, and the values Δt_{c} or Δtᵢ can be input to the quantizer circuitry 204 through signal 203-3.

In another embodiment, the set of I/Q modulator circuitry IQM−{1, . . . ,N_{bq}} can be replaced by an I/Q DAC.

In another embodiment, feedback signals from the pairs of outputs of the set of mixer circuitry 208−{1, . . . ,N_{bq}} can be provided to the mapper circuitry 206 operable to generates time or phase control information for the set of I/Q modulator circuitry IQM-{1, . . . ,N_{bq}}, to enable time or phase synchronization of the set of RF bandpass components 211-{1, . . . ,N_{bq}}.

In another embodiment, feedback signals F1, F2, F3, F4 from the set of bandpass components 209−{1, . . . ,N_{bq}} can be input to the mapper circuitry 206 operable to generate time or phase control information signals for the I/Q modulators IQM−{1, . . . ,N_{bq}}, to enable the set of RF bandpass components to be time or phase aligned.

In another embodiment, the system 200 can be configured to receive the reference clock signal 201-3 having the intermediate frequency fᵢ, the oscillator circuitry C1 can be operable to generate the sinusoidal reference signal C2 having the intermediate frequency fᵢ given by the reference signal 201-3, to be applied to the set of I/Q modulator circuitry IQM−{1, . . . ,N_{bq}} and the input signal OC-1 having the RF carrier frequency f_{c} provides a reference signal to the set of mixer circuitry OM1−{, . . . ,N_{bq}} operable to up-convert the set of bandpass components 211−{1, . . . ,N_{bq}}.

In another embodiment, feedback signals F1, F2, F3, F4 output from the set of mixer circuitry 208−{i₁, . . . ,i_{Nbq}}, 208−{q₁, . . . ,q_{Nbq}} are provided to the mapper circuitry 206 operable to generate time or phase control information for the set of I/Q modulator circuitry IQM−{1, . . . ,N_{bq}} to enable the set of RF bandpass components 209−{i₁, . . . ,i_{Nbq}}, 209−{q₁, . . . ,q_{Nbq}} at the outputs of the set of mixer circuitry 208−{i₁, . . . ,i_{Nbq}}, 208−{q₁, . . . ,q_{Nbq}} can be time or phase aligned.

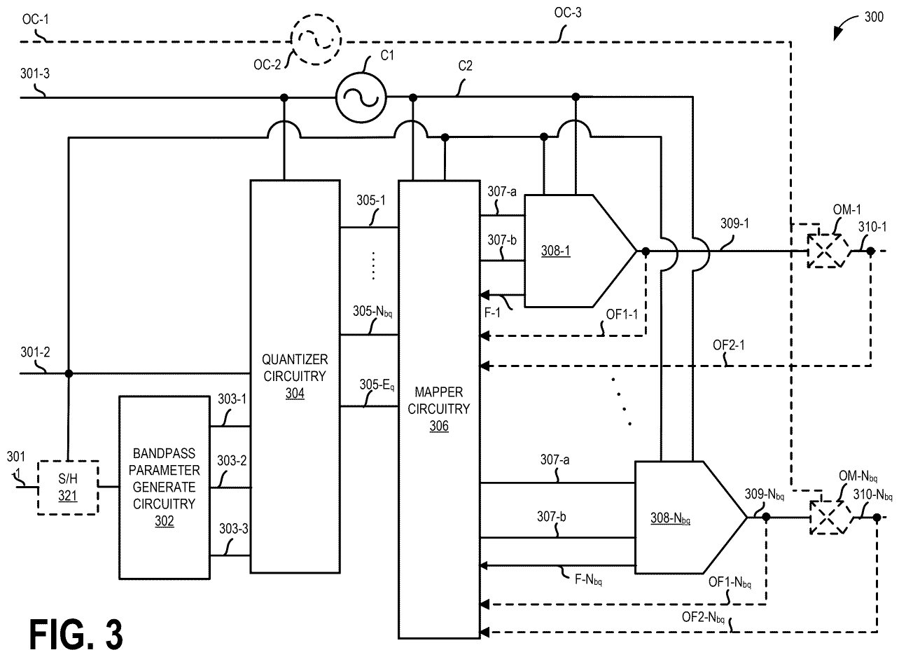

FIG. 3 illustrates one embodiment of a system 300 of performing baseband digital to analog conversion with direct quantization and decomposition into bandpass components using DACs in accordance with various aspects as described herein. In FIG. 3, the system 300 can be configured to receive input signal 301-1 having the time samples s_{BBn} of a baseband signal s_{BB}(t). In one example, the input signal 301-1 can include the samples s_{l,n} and s_{Q,n} of the in-phase and quadrature-phase components of a baseband signal. In another example, the input signal 301-2 can be a baseband signal s_{BB}(t) which is sampled by sampling circuitry or sample and hold circuitry 321 operable to generate the time samples s_{BBn} of s_{BB} (t).

In FIG. 3, the system 300 can be further configured to receive a clock reference signal 301-2 with the sampling frequency fₛ, a reference clock signal 301-3 with the RF frequency f_{c}. In one example, the system 300 can be configured to receive the reference clock signal 301-3 having an intermediate frequency fᵢ and the clock signal OC-1 having a desired RF carrier frequency f_{c}. The clock signal 301-2 can be a clock reference signal having a sampling frequency for input to the sampling circuitry or the sample and hold circuitry 321 operable to sample the input signal, a bandpass parameters generate circuitry 302 operable to compute the amplitude Aₙ and the phase αₙ of each sample, a quantizer circuitry 304 operable to quantize the amplitude Aₙ to obtain the quantized the amplitude A_{qn}, a mapper circuitry 306 operable to generate a set of in-phase and quadrature-phase mapping components, a set of I/Q DAC circuitry 308−{1, . . . ,N_{bq}} operable to generate the active set of N′≤N_{bq} bandpass components 309−{1, . . . ,N_{bq}}, or the like. The clock signals 301-2, 301-3 can enable time or phase synchronization of the circuitry 303, 304, 306 and among the set of bandpass components 309−{1, . . . , N_{bq}}.

In FIG. 3, the bandpass parameters generate circuitry 302 can be operable to receive the samples S_{BBn} of a baseband signal s_{BB}(t), and can compute, for each sample, an amplitude

$${A}_{n} = \sqrt{{s}_{I , n}^{2} + {s}_{Q , n}^{2}} ,$$

a phase αₙ=ATAN4(s_{Q,n}/s_{I,n}), Δt_{c}=mod (Δt+nT_{S},T_{c}) or Δtᵢ=mod (Δt+nT_{S},Tᵢ). The amplitude Aₙ 303-1 and the phase αₙ 303-2 of each sample, and the values Δt_{c} or Δtᵢ 303-3 can be input to the quantizer circuitry 304. The quantizer circuitry 304 can be operable to quantize the amplitude Aₙ of each sample, generate the quantized amplitude A_{qn}=Aₙ+e_{q} and the set of quantization amplitude bits 305−{1, . . . ,N_{bq}}, compute the quantization error e_{q} as the difference between the amplitude Aₙ and the quantized amplitude A_{qn}. The quantizer circuitry 204 can also be operable to quantize the quantization amplitude error e_{q} into a quantized quantization amplitude error e_{qQ} based on a LUT circuitry having values representing N_{q} quantization intervals. The mapper circuitry 306 can be operable to receive the quantization bits 305−{1, . . . ,N_{bq}} together with the quantized quantization error 305-E_{q} and can generate an active set of N′≤N_{bq} pairs of in-phase and quadrature-phase mapping components based on a mapping rule table that can be stored in a LUT circuitry configured to include the quantization amplitude bit combinations, the sets of discrete amplitudes aᵢ, the set of quantized values, the finite set of possible values for the quantized quantization error e_{qQ}.

In the current embodiment, the mapper circuitry 306 can be operable to compute, based on the mapping rule table, the quantization bits and the set of discrete amplitudes aᵢ={a₁, a₂, . . . , a_{Nbq}} in which a quantized value of the sample can be decomposed, the coefficients C_{i,n} (C_{i,n}=±1 or 0) needed to map the quantized value into an active set of N′≤N_{bq} pairs of in-phase s_{I,i} and quadrature-phase s_{Q,i} mapping components 307−{i₁, . . . ,i_{Nbq}}, 307−{q₁, . . . ,q_{Nbq}}, given by C_{i,n}aᵢ cos (αₙ) and C_{i,n}aᵢ sin (αₙ) with i={1, . . . ,N_{bq}}. Note that the sum of these components corresponds for each sample to a quantized representation of the input signal given by

$${S}_{B Bnq} = {\sum }_{i = 1}^{N b q} {C}_{i , n} {a}_{i} cos ( {α}_{n} ) + j {\sum }_{i = 1}^{N b q} {C}_{i , n} {a}_{i} sin ( {α}_{n} ) = {\sum }_{i = 1}^{N b q} {s}_{I , i} + j {s}_{Q , i} .$$

The mapper circuitry 306 can be further operable to provide the set of pairs of in-phase and quadrature-phase components 307-{i₁, . . . ,i_{Nbq}}, 307−{q₁, . . . ,q_{Nbq}}, to a set of N_{bq} I/Q DACs 308−{1, . . . ,N_{bq}} to generate the active set of N′≤N_{bq} RF bandpass components 309−{1, . . . ,N_{bq}}, each RF bandpass component over the sampling interval Δt+nT_{S}≤tₛ≤Δt+(n+1)T_{S} given by s_{BPn,i}=S_{BP}(tₛ)=C_{i,n}aᵢ cos (2πf_{c}tₛ+αₙ).

In another embodiment, the mapper circuitry 306 can be operable to provide the amplitudes aᵢ and the phase αₙ to control the initial phase of the sinusoidal signals generated by a set of I/Q modulators or I/Q DACs by the set of I/Q modulators or I/Q DACs for each sampling interval.

In another embodiment, the mapper circuitry 306 can be operable to receive the quantized quantization error e_{qQ} 305-E_{q} that is weighted added to the discrete amplitudes aᵢ of the active set of pairs of mapping components.

In another embodiment, the quantized quantization error e_{qQ} can be added to the smallest active mapping component, the largest active mapping component, one arbitrary active mapping component, or the like.

In FIG. 3, the mapper circuitry 206 can be configured to receive, from the set of the I/Q DACs 308−{1, . . . ,N_{bq}}, feedback signals F−{1, . . . ,N_{bq}} to generate time or phase control information to enable the set of RF bandpass components to be time or phase aligned.

In another embodiment, the set of N_{bq} I/Q DACs can be operable to generate the active set of bandpass components at the intermediate frequency fᵢ and the set of N_{bq} mixer circuitry can be operable to up-convert the active set of N′≤N_{bq} bandpass components to the carrier RF frequency f_{c}.

In FIG. 3, a local oscillator circuitry C1 can be operable to generate a sinusoidal reference signal C2 having an intermediate frequency fᵢ or a sinusoidal reference signal 301-3 having an RF carrier frequency f_{c} given by the reference signal 301-3, to be input to the set of I/Q DACs 307−{1, . . . ,N_{bq}}.

In another embodiment, when the system 300 is configured to receive the reference clock signal 301-3 having an intermediate frequency fᵢ, the oscillator circuitry C1 can be operable to generate a sinusoidal reference signal C2 having an intermediate frequency fᵢ based on the reference signal 301-3, to be input to the set of I/Q DACs 307−{1, . . . ,N_{bq}}. Further, the input signal OC-1 having the carrier RF frequency f_{c} can be a reference clock signal for input to the set of mixer circuitry OM1−{1, . . . ,N_{bq}} to up-convert the set of bandpass mapping components 309−{1, . . . ,N_{bq}}. Also, feedbacks F1−{1, . . . ,N_{bq}} are provided to the mapper that generates phase and time control info for the I/Q DACs 308−{1, . . . ,N_{bq}} needed to assure that all RF bandpass components at mixers' outputs are time and phase aligned.

In another embodiment, the mapper circuitry 306 can be configured to receive, from the set of mixer circuitry OM1−{1, . . . ,N_{bq}}, feedback signals OF2−{1, . . . ,N_{bq}} to generate time or phase control information for the set of DACs 308−{1, . . . ,N_{bq}} to enable the set of RF bandpass components 310−{1, . . . ,N_{bq}} output by the set of mixer circuitry OM1−{1, . . . ,N_{bq}} to be time or phase aligned.

In another embodiment, the set of RF quantization components 310−{1, . . . ,N_{bq}} can be obtained by multiplying in 308−{1, . . . ,N_{bq}} the IF quantization component 309−{1, . . . ,N_{bq}} by a periodic signal OC-3, generated by an oscillator OC-2 having the desired RF carrier frequency f_{c} for the output signal.

In another embodiment, the mapper circuitry 306 can be operable to receive, from the outputs of the set of DACs 309−{1, . . . ,N_{bq}}, feedback signals OF−{1, . . . ,N_{bq}} to generates time or phase control information for the set of DACs 309−{1, . . . ,N_{bq}} to enable the set of RF bandpass components to be time or phase aligned.

In another embodiment, the mapper circuitry 306 can be operable to receive, from the outputs of the set of mixer circuitry OM1−{1, . . . ,N_{bq}}, feedback signals to generate time or phase control information for the set of DACs 308−{1, . . . ,N_{bq}} to enable the set of RF bandpass components to be time or phase aligned.

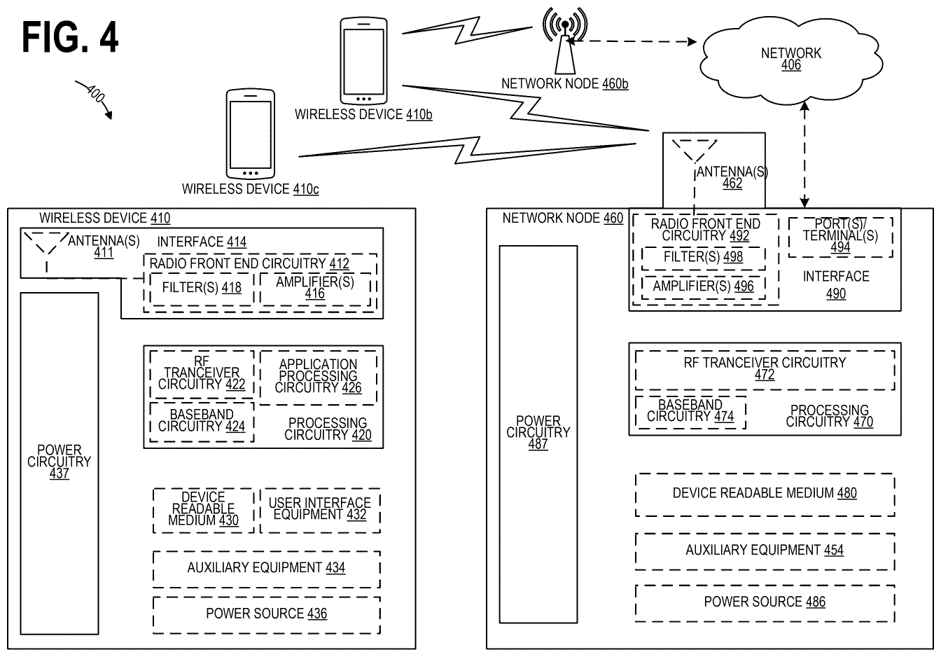

Although the subject matter described herein may be implemented in any appropriate type of system using any suitable components, the embodiments disclosed herein may also be described in relation to a wireless network, such as the example wireless network illustrated in FIG. 4. For simplicity, the wireless network of FIG. 4 only depicts network 406, network nodes 460 and 460b, and wireless devices 410, 410b, and 410c. In practice, a wireless network may further include any additional elements suitable to support communication between wireless devices or between a wireless device and another communication device, such as a landline telephone, a service provider, or any other network node or end device. Of the illustrated components, network node 460 and wireless device 410 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, 5G, 6G standards; wireless local area network (WLAN) standards, such as the IEEE 402.11 standards; and/or any other appropriate wireless communication standard, such as the Worldwide Interoperability for Microwave Access (WiMax), Bluetooth, Z-Wave and/or ZigBee standards.

Network 406 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 460 and wireless device 410 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs), and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O & M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 460 includes processing circuitry 470, device readable medium 480, interface 490, auxiliary equipment 454, power source 456, power circuitry 457, and antenna 462. Although network node 460 illustrated in the example wireless network of FIG. 4 may represent a device that includes the illustrated combination of hardware components, other embodiments may comprise network nodes with different combinations of components. It is to be understood that a network node comprises any suitable combination of hardware and/or software to perform the tasks, features, functions and methods disclosed herein. Moreover, while the components of network node 460 are depicted as single boxes located within a larger box, or nested within multiple boxes, in practice, a network node may comprise multiple different physical components that make up a single illustrated component (e.g., device readable medium 480 may comprise multiple separate hard drives as well as multiple random access memory (RAM) modules).

Similarly, network node 460 may be composed of multiple physically separate components (e.g., a NodeB component and a radio network controller (RNC) component, or a BTS component and a BSC component, etc.), which may each have their own respective components. In certain scenarios in which network node 460 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 460 may be configured to support multiple radio access technologies (RATs). In such embodiments, some components may be duplicated (e.g., separate device readable medium 480 for the different RATs) and some components may be reused (e.g., the same antenna 462 may be shared by the RATs). Network node 460 may also include multiple sets of the various illustrated components for different wireless technologies integrated into network node 460, such as, for example, GSM, code division multiple access (CDMA), wideband code division multiple access (WCDMA), LTE, NR, Wi-Fi, or Bluetooth wireless technologies. These wireless technologies may be integrated into the same or different chip or set of chips and other components within network node 460.

Processing circuitry 470 is configured to perform any determining, calculating, or similar operations (e.g., certain obtaining operations) described herein as being provided by a network node. These operations performed by processing circuitry 470 may include processing information obtained by processing circuitry 470 by, for example, converting the obtained information into other information, comparing the obtained information or converted information to information stored in the network node, and/or performing one or more operations based on the obtained information or converted information, and as a result of said processing making a determination.

Processing circuitry 470 may comprise a combination of one or more of a microprocessor, controller, microcontroller, central processing unit, digital signal processor (DSP), application-specific integrated circuitry (ASIC), field-programmable gate array (FPGA), or any other suitable computing device, resource, or combination of hardware, software and/or encoded logic operable to provide, either alone or in conjunction with other network node 460 components, such as device readable medium 480, network node 460 functionality. For example, processing circuitry 470 may execute instructions stored in device readable medium 480 or in memory within processing circuitry 470. Such functionality may include providing any of the various wireless features, functions, or benefits discussed herein. In some embodiments, processing circuitry 470 may include a system on a chip (SOC).

In some embodiments, processing circuitry 470 may include one or more of RF transceiver circuitry 472 and baseband processing circuitry 474. In some embodiments, RF transceiver circuitry 472 and baseband processing circuitry 474 may be on separate chips (or sets of chips), boards, or units, such as radio units and digital units. In alternative embodiments, part or all of RF transceiver circuitry 472 and baseband processing circuitry 474 may be on the same chip or set of chips, boards, or units. The embodiments described by this disclosure can be implemented for the network node 460 in the interface 490 and/or the processing circuitry 470. Further, the embodiments described by this disclosure can be implemented for the wireless device or user equipment 410 in the interface 414 and/or the processing circuitry 420.

In certain embodiments, some or all of the functionality described herein as being provided by a network node, base station, eNB or other such network device may be performed by processing circuitry 470 executing instructions stored on device readable medium 480 or memory within processing circuitry 470. In alternative embodiments, some or all of the functionalities may be provided by processing circuitry 470 without executing instructions stored on a separate or discrete device readable medium, such as in a hard-wired manner. In any of those embodiments, whether executing instructions stored on a device readable storage medium or not, processing circuitry 470 may be configured to perform the described functionality. The benefits provided by such functionality are not limited to processing circuitry 470 alone or to other components of network node 460 but are enjoyed by network node 460 as a whole, and/or by end users and the wireless network generally.

Device readable medium 480 may comprise any form of volatile or non-volatile computer readable memory including, without limitation, persistent storage, solid-state memory, remotely mounted memory, magnetic media, optical media, RAM, read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 470. Device readable medium 480 may store any suitable instructions, data or information, including a computer program, software, an application including one or more of logic, rules, code, tables, etc. and/or other instructions capable of being executed by processing circuitry 470 and, utilized by network node 460. Device readable medium 480 may be used to store any calculations made by processing circuitry 470 and/or any data received via interface 490. In some embodiments, processing circuitry 470 and device readable medium 480 may be integrated.

Interface 490 is used in the wired or wireless communication of signaling and/or data between network node 460, network 406, and/or wireless devices 410,410b, 410c. As illustrated, interface 490 comprises port(s)/terminal(s) 494 to send and receive data, for example to and from network 406 over a wired connection. Interface 490 also includes radio front end circuitry 492 that may be coupled to, or in certain embodiments a part of, antenna 462. Radio front end circuitry 492 comprises filters 498 and amplifiers 496. Radio front end circuitry 492 may be connected to antenna 462 and processing circuitry 470. Radio front end circuitry may be configured to condition signals communicated between antenna 462 and processing circuitry 470. Radio front end circuitry 492 may receive digital data that is to be sent out to other network nodes or wireless devices via a wireless connection. Radio front end circuitry 492 may convert the digital data into a radio signal having the appropriate channel and bandwidth parameters using a combination of filters 498 and/or amplifiers 496. The radio signal may then be transmitted via antenna 462. Similarly, when receiving data, antenna 462 may collect radio signals which are then converted into digital data by radio front end circuitry 492. The digital data may be passed to processing circuitry 470. In other embodiments, the interface may comprise different components and/or different combinations of components.

In certain alternative embodiments, network node 460 may not include separate radio front end circuitry 492, instead, processing circuitry 470 may comprise radio front end circuitry and may be connected to antenna 462 without separate radio front end circuitry 492. Similarly, in some embodiments, all or some of RF transceiver circuitry 472 may be considered a part of interface 490. In still other embodiments, interface 490 may include one or more ports or terminals 494, radio front end circuitry 492, and RF transceiver circuitry 472, as part of a radio unit (not shown), and interface 490 may communicate with baseband processing circuitry 474, which is part of a digital unit (not shown).

Antenna 462 may include one or more antennas, or antenna arrays, configured to send and/or receive wireless signals. Antenna 462 may be coupled to radio front end circuitry 490 and may be any type of antenna capable of transmitting and receiving data and/or signals wirelessly. In some embodiments, antenna 462 may comprise one or more omni-directional, sector or panel antennas operable to transmit/receive radio signals between, for example, 2 GHz and 46 GHz. An omni-directional antenna may be used to transmit/receive radio signals in any direction, a sector antenna may be used to transmit/receive radio signals from devices within a particular area, and a panel antenna may be a line-of-sight antenna used to transmit/receive radio signals in a relatively straight line. In some instances, the use of more than one antenna may be referred to as multiple-input multiple-output (MIMO). In certain embodiments, antenna 462 may be separate from network node 460 and may be connectable to network node 460 through an interface or port.

Antenna 462, interface 490, and/or processing circuitry 470 may be configured to perform any receiving operations and/or certain obtaining operations described herein as being performed by a network node. Any information, data and/or signals may be received from a wireless device, another network node and/or any other network equipment. Similarly, antenna 462, interface 490, and/or processing circuitry 470 may be configured to perform any transmitting operations described herein as being performed by a network node. Any information, data and/or signals may be transmitted to a wireless device, another network node and/or any other network equipment.

Power circuitry 487 may comprise, or be coupled to, power management circuitry and is configured to supply the components of network node 460 with power for performing the functionality described herein. Power circuitry 487 may receive power from power source 486. Power source 486 and/or power circuitry 487 may be configured to provide power to the various components of network node 460 in a form suitable for the respective components (e.g., at a voltage and current level for each respective component). Power source 486 may either be included in, or external to, power circuitry 487 and/or network node 460. For example, network node 460 may be connectable to an external power source (e.g., an electricity outlet) via an input circuitry or interface such as an electrical cable, whereby the external power source supplies power to power circuitry 487. As a further example, power source 486 may comprise a source of power in the form of a battery or battery pack which is connected to, or integrated in, power circuitry 487. The battery may provide backup power should the external power source fail. Other types of power sources, such as photovoltaic devices, may also be used.

Alternative embodiments of network node 460 may include additional components beyond those shown in FIG. 4 that may be responsible for providing certain aspects of the network node's functionality, including any of the functionality described herein and/or any functionality necessary to support the subject matter described herein. For example, network node 460 may include user interface equipment to allow input of information into network node 460 and to allow output of information from network node 460. This may allow a user to perform diagnostic, maintenance, repair, and other administrative functions for network node 460.

As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3rd Generation Partnership Project (3GPP) standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one example, the wireless device may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 410 includes antenna 411, interface 414, processing circuitry 420, device readable medium 430, user interface equipment 432, auxiliary equipment 434, power source 436 and power circuitry 437. Wireless device 410 may include multiple sets of one or more of the illustrated components for different wireless technologies supported by wireless device 410, such as, for example, GSM, WCDMA, LTE, NR, Wi-Fi, WiMAX, NB-IoT, or Bluetooth wireless technologies, just to mention a few. These wireless technologies may be integrated into the same or different chips or set of chips as other components within wireless device 410.

Antenna 411 may include one or more antennas or antenna arrays, configured to send and/or receive wireless signals, and is connected to interface 414. In certain alternative embodiments, antenna 411 may be separate from wireless device 410 and be connectable to wireless device 410 through an interface or port. Antenna 411, interface 414, and/or processing circuitry 420 may be configured to perform any receiving or transmitting operations described herein as being performed by a wireless device. Any information, data and/or signals may be received from a network node and/or another wireless device. In some embodiments, radio front end circuitry and/or antenna 411 may be considered an interface.

As illustrated, interface 414 comprises radio front end circuitry 412 and antenna 411. Radio front end circuitry 412 comprise one or more filters 418 and amplifiers 416. Radio front end circuitry 412 is connected to antenna 411 and processing circuitry 420 and is configured to condition signals communicated between antenna 411 and processing circuitry 420. Radio front end circuitry 412 may be coupled to or a part of antenna 411. In some embodiments, wireless device 410 may not include separate radio front end circuitry 412; rather, processing circuitry 420 may comprise radio front end circuitry and may be connected to antenna 411. Similarly, in some embodiments, some or all of RF transceiver circuitry 422 may be considered a part of interface 414. Radio front end circuitry 412 may receive digital data that is to be sent out to other network nodes or wireless devices via a wireless connection. Radio front end circuitry 412 may convert the digital data into a radio signal having the appropriate channel and bandwidth parameters using a combination of filters 418 and/or amplifiers 416. The radio signal may then be transmitted via antenna 411. Similarly, when receiving data, antenna 411 may collect radio signals which are then converted into digital data by radio front end circuitry 412. The digital data may be passed to processing circuitry 420. In other embodiments, the interface may comprise different components and/or different combinations of components.

Processing circuitry 420 may comprise a combination of one or more of a microprocessor, controller, microcontroller, central processing unit, DSP, ASIC, FPGA, or any other suitable computing device, resource, or combination of hardware, software, and/or encoded logic operable to provide, either alone or in conjunction with other wireless device 410 components, such as device readable medium 430, wireless device 410 functionality. Such functionality may include providing any of the various wireless features or benefits discussed herein. For example, processing circuitry 420 may execute instructions stored in device readable medium 430 or in memory within processing circuitry 420 to provide the functionality disclosed herein.

As illustrated, processing circuitry 420 includes one or more RF transceiver circuitry 422, baseband processing circuitry 424, and application processing circuitry 426. In other embodiments, the processing circuitry may comprise different components and/or different combinations of components. In certain embodiments processing circuitry 420 of wireless device 410 may comprise a SOC. In some embodiments, RF transceiver circuitry 422, baseband processing circuitry 424, and application processing circuitry 426 may be on separate chips or sets of chips. In alternative embodiments, part or all of baseband processing circuitry 424 and application processing circuitry 426 may be combined into one chip or set of chips, and RF transceiver circuitry 422 may be on a separate chip or set of chips. In still alternative embodiments, part or all of RF transceiver circuitry 422 and baseband processing circuitry 424 may be on the same chip or set of chips, and application processing circuitry 426 may be on a separate chip or set of chips. In yet other alternative embodiments, part or all of RF transceiver circuitry 422, baseband processing circuitry 424, and application processing circuitry 426 may be combined in the same chip or set of chips. In some embodiments, RF transceiver circuitry 422 may be a part of interface 414. RF transceiver circuitry 422 may condition RF signals for processing circuitry 420.

In certain embodiments, some or all of the functionality described herein as being performed by a wireless device may be provided by processing circuitry 420 executing instructions stored on device readable medium 430, which in certain embodiments may be a computer-readable storage medium. In alternative embodiments, some or all of the functionalities may be provided by processing circuitry 420 without executing instructions stored on a separate or discrete device readable storage medium, such as in a hard-wired manner. In any of those embodiments, whether executing instructions stored on a device readable storage medium or not, processing circuitry 420 may be configured to perform the described functionality. The benefits provided by such functionality are not limited to processing circuitry 420 alone or to other components of wireless device 410 but are enjoyed by wireless device 410 as a whole, and/or by end users and the wireless network generally.

Processing circuitry 420 may be configured to perform any determining, calculating, or similar operations (e.g., certain obtaining operations) described herein as being performed by a wireless device. These operations, as performed by processing circuitry 420, may include processing information obtained by processing circuitry 420 by, for example, converting the obtained information into other information, comparing the obtained information or converted information to information stored by wireless device 410, and/or performing one or more operations based on the obtained information or converted information, and as a result of said processing making a determination.

Device readable medium 430 may be operable to store a computer program, software, an application including one or more of logic, rules, code, tables, etc. and/or other instructions capable of being executed by processing circuitry 420. Device readable medium 430 may include computer memory (e.g., RAM or ROM), mass storage media (e.g., a hard disk), removable storage media (e.g., CD, DVD), and/or any other volatile or non-volatile, non-transitory device readable and/or computer executable memory devices that store information, data, and/or instructions that may be used by processing circuitry 420. In some embodiments, processing circuitry 420 and device readable medium 430 may be integrated.

User interface equipment 432 may provide components that allow for a human user to interact with wireless device 410. Such interaction may be of many forms, such as visual, audial, tactile, etc. User interface equipment 432 may be operable to produce output to the user and to allow the user to provide input to wireless device 410. The type of interaction may vary depending on the type of user interface equipment 432 installed in wireless device 410. For example, if wireless device 410 is a smart phone, the interaction may be via a touch screen; if wireless device 410 is a smart meter, the interaction may be through a screen that provides usage (e.g., the number of gallons used) or a speaker that provides an audible alert (e.g., if smoke is detected). User interface equipment 432 may include input interfaces, devices and circuits, and output interfaces, devices and circuits. User interface equipment 432 is configured to allow input of information into wireless device 410 and is connected to processing circuitry 420 to allow processing circuitry 420 to process the input information. User interface equipment 432 may include, for example, a microphone, a proximity or other sensor, keys/buttons, a touch display, one or more cameras, a USB port, or other input circuitry. User interface equipment 432 is also configured to allow output of information from wireless device 410, and to allow processing circuitry 420 to output information from wireless device 410. User interface equipment 432 may include, for example, a speaker, a display, vibrating circuitry, a USB port, a headphone interface, or other output circuitry. Using one or more input and output interfaces, devices, and circuits, of user interface equipment 432, wireless device 410 may communicate with end users and/or the wireless network and allow them to benefit from the functionality described herein.

Auxiliary equipment 434 is operable to provide more specific functionality which may not be generally performed by wireless devices. This may comprise specialized sensors for performing measurements for various purposes, interfaces for additional types of communication such as wired communications etc. The inclusion and type of components of auxiliary equipment 434 may vary depending on the embodiment and/or scenario.

Power source 436 may, in some embodiments, be in the form of a battery or battery pack. Other types of power sources, such as an external power source (e.g., an electricity outlet), photovoltaic devices or power cells, may also be used. The wireless device 410 may further comprise power circuitry 437 for delivering power from power source 436 to the various parts of wireless device 410 which need power from power source 436 to carry out any functionality described or indicated herein. Power circuitry 437 may in certain embodiments comprise power management circuitry. Power circuitry 437 may additionally or alternatively be operable to receive power from an external power source; in which case wireless device 410 may be connectable to the external power source (such as an electricity outlet) via input circuitry or an interface such as an electrical power cable. Power circuitry 437 may also, in certain embodiments, be operable to deliver power from an external power source to power source 436. This may be, for example, for the charging of power source 436. Power circuitry 437 may perform any formatting, converting, or other modification to the power from power source 436 to make the power suitable for the respective components of wireless device 410 to which power is supplied.

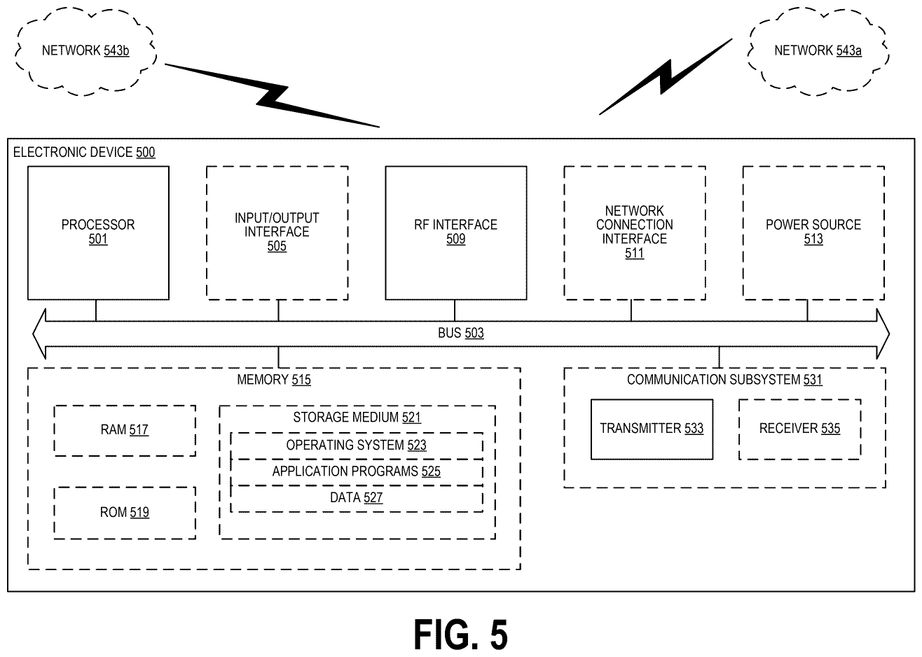

FIG. 5 illustrates one embodiment of an electronic device 500 in accordance with various aspects described herein. As used herein, device 500 can be a wired device, wireless device or both. Further, device 500 may not necessarily have a user in the sense of a human user who owns and/or operates the relevant device. Instead, device 500 may represent a device that is intended for sale to, or operation by, a human user but which may not, or which may not initially, be associated with a specific human user (e.g., a smart sprinkler controller, IoT device). Alternatively, device 500 may represent a device that is not intended for sale to, or operation by, an end user but which may be associated with or operated for the benefit of a user (e.g., a smart power meter). Device 500 may be UE identified by the 3GPP, including a NB-IoT UE, a machine type communication (MTC) UE, and/or an enhanced MTC (eMTC) UE. Device 500, as illustrated in FIG. 5, is one example of a device configured for wired or wireless communication in accordance with one or more communication standards such as promulgated by the 3GPP, such as 3GPP's GSM, UMTS, LTE, and/or 5G standards.

Device 500 can include any electronic device that has an amplifier. In one example, device 500 can include an audio or music device, home audio system, stereo amplifier, audio or video receiver, home theater system, powered speaker, subwoofer, karaoke machine, musical equipment, guitar amplifier, bass amplifier, keyboard amplifier, public address system, studio monitor, headphone or earbud, noise-canceling headphone, portable audio device, Bluetooth speaker, portable amplifier for headphones or instrument, or the like. In another example, device 500 can include a wireless device, user equipment, network node, base station, broadcast or communication device, radio transmitter, wireless communication equipment, satellite communication system, Wi-Fi router, extended range device, telecommunication device, microwave repeater, radar system, or the like. In yet another example, device 500 can include consumer electronics, televisions, internal audio amplifier for a speaker, external soundbar with built-in amplifier, computer or gaming device, sound card with integrated amplifier, DAC with amplifier, smartphone, tablet, built-in audio amplifier for speaker or headphone, or the like. In yet another example, device 500 can include automotive or transportation device, car audio system, car amplifier, subwoofer amplifier, marine audio system, amplifier for boat or watercraft, aircraft communication system, amplifier for cockpit communication or in-flight entertainment, or the like. In yet another example, device 500 can include industrial and professional equipment, public address system, amplifier for a large venue, school or stadium, concert or event equipment, power amplifier for a loudspeaker, line array system, medical equipment, ultrasound machine, hearing aids, or the like. In yet another example, device 500 can include RF or specialized equipment, RF amplifier, signal booster for a cell tower, satellite uplink or downlink device, test or measurement instrument, oscilloscope, spectrum analyzer, military or aerospace equipment, radar system, communication jammer, or the like. In yet another example, device 500 can include toy or hobby device, radio-controlled car, plane or drone, smart home device, smart speaker, voice assistant device, or the like.

In FIG. 5, device 500 includes processing circuitry 501 that is operatively coupled to input/output interface 505, RF interface 509, network connection interface 511, memory 515 including RAM 517, ROM 519, and storage medium 521 or the like, communication subsystem 531, power source 513, and/or any other component, or any combination thereof. Storage medium 521 includes operating system 523, application program 525, and data 527. In other embodiments, storage medium 521 may include other similar types of information. Certain electronic devices may utilize all of the components shown in FIG. 5, or only a subset of the components. The level of integration between the components may vary from one device to another device. Further, certain electronic devices may contain multiple instances of a component, such as multiple processors, memories, transceivers, transmitters, receivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or DSP, together with appropriate software; or any combination of the above. For example, the processing circuitry 501 may include two central processing units (CPUs). Data may be information in a form suitable for use by a computer.

In the depicted embodiment, input/output interface 505 may be configured to provide a communication interface to an input device, output device, or input and output device. Device 500 may be configured to use an output device via input/output interface 505. An output device may use the same type of interface port as an input device. For example, a USB port may be used to provide input to and output from device 500. The output device may be a speaker, a sound card, a video card, a display, a monitor, a printer, an actuator, an emitter, a smartcard, another output device, or any combination thereof. Device 500 may be configured to use an input device via input/output interface 505 to allow a user to capture information into device 500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, or an optical sensor.

In FIG. 5, RF interface 509 may be configured to provide a communication interface to RF components such as a transmitter, a receiver, and an antenna. Network connection interface 511 may be configured to provide a communication interface to network 543a. Network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. Network connection interface 511 may be configured to include a receiver and a transmitter interface used to communicate with one or more other devices over a communication network according to one or more communication protocols, such as Ethernet, TCP/IP, synchronous optical networking (SONET), asynchronous transfer mode (ATM), or the like. Network connection interface 511 may implement receiver and transmitter functionality appropriate to the communication network links (e.g., optical, electrical, and the like). The transmitter and receiver functions may share circuitry components, software or firmware, or alternatively may be implemented separately.

RAM 517 may be configured to interface via bus 502 to processing circuitry 501 to provide storage or caching of data or computer instructions during the execution of software programs such as the operating system, application programs, and device drivers. ROM 519 may be configured to provide computer instructions or data to processing circuitry 501. For example, ROM 519 may be configured to store invariant low-level system code or data for basic system functions such as basic input and output (1/O), startup, or reception of keystrokes from a keyboard that are stored in a non-volatile memory. Storage medium 521 may be configured to include memory such as RAM, ROM, programmable ROM (PROM), erasable PROM (EPROM), electrically erasable PROM (EEPROM), magnetic disks, optical disks, floppy disks, hard disks, removable cartridges, or flash drives. In one example, storage medium 521 may be configured to include operating system 523, application program 525 such as a web browser application, a widget or gadget engine or another application, and data file 527. Storage medium 521 may store, for use by device 500, any of a variety of various operating systems or combinations of operating systems.

Storage medium 521 may be configured to include a number of physical drive units, such as redundant array of independent disks (RAID), floppy disk drive, flash memory, USB flash drive, external hard disk drive, thumb drive, pen drive, key drive, high-density DVD (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 521 may allow device 500 to access computer-executable instructions, application programs or the like, stored on transitory or non-transitory memory media, to off-load data, or to upload data. An article of manufacture, such as one utilizing a communication system may be tangibly embodied in storage medium 521, which may comprise a device readable medium.

In FIG. 5, processing circuitry 501 may be configured to communicate with network 543b using communication subsystem 531. Network 543a and network 543b may be the same network or networks or different network or networks. Communication subsystem 531 may be configured to include one or more transceivers used to communicate with network 543b. For example, communication subsystem 531 may be configured to include one or more transceivers used to communicate with one or more remote transceivers of another device capable of wireless communication such as another electronic device, wireless device, UE, or base station of a radio access network (RAN) according to one or more communication protocols, such as IEEE 802.11, CDMA, WCDMA, GSM, LTE, UMTS terrestrial radio access network (UTRAN), WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuitry components, software or firmware, or alternatively may be implemented separately.

In the illustrated embodiment, the communication functions of communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 531 may include cellular communication, Wi-Fi communication, Bluetooth communication, and GPS communication. Network 543b may encompass wired and/or wireless networks such as a LAN, a WAN, a computer network, a wireless network, a telecommunications network, another like network or any combination thereof. For example, network 543b may be a cellular network, a Wi-Fi network, and/or a near-field network. Power source 513 may be configured to provide alternating current (AC) or direct current (DC) power to components of device 500.

The features, benefits and/or functions described herein may be implemented in one of the components of device 500 or partitioned across multiple components of device 500. Further, the features, benefits, and/or functions described herein may be implemented in any combination of hardware, software or firmware. In one example, communication subsystem 531 may be configured to include any of the components described herein. Further, processing circuitry 501 may be configured to communicate with any of such components over bus 502. In another example, any of such components may be represented by program instructions stored in memory that when executed by processing circuitry 501 perform the corresponding functions described herein. In another example, the functionality of any of such components may be partitioned between processing circuitry 501 and communication subsystem 531. In another example, the non-computationally intensive functions of any of such components may be implemented in software or firmware and the computationally intensive functions may be implemented in hardware. The embodiments described by this disclosure can be implemented for the device 500 in the RF interface block 509 or the transmitter block 533 of the communication subsystem 531.

Those skilled in the art will also appreciate that embodiments herein further include corresponding computer programs.

A computer program comprises instructions which, when executed on at least one processor of an apparatus, cause the apparatus to carry out any of the respective processes described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method of performing digital baseband to analog conversion with direct quantization and decomposition into bandpass components includes receiving samples of a baseband signal s_{BBn}=s_{BB}(tₙ)=s_{l,n}+j s_{Q,n}=Aₙ cos (αₙ)+j Aₙ sin (αₙ)=Aₙ exp (j αₙ), where to denotes a sampling instant, s_{l,n}=Aₙ cos (αₙ), s_{Q,n}=Aₙ sin (αₙ),

$${A}_{n} = \sqrt{{s}_{I , n}^{2} + {s}_{Q , n}^{2}} , {α}_{n} = A TAN ( {s}_{Q , n} / {s}_{I , n} )$$

and s_{l,n} and s_{Qn} represent the in-phase and quadrature-phase components of the baseband signal s_{BB}(t); receiving a clock signal according to the sample rate of the input signal fₛ=1/T_{S}; receiving a clock signal set according to an intermediate frequency fᵢ; receiving a clock signal in accordance with an output RF f_{c}; computing the phase αₙ and the amplitude Aₙ of each sample and the cosine and sine of the computed phase αₙ; quantizing in a quantizer with N_{bq} quantization bits the amplitude Aₙ of each sample s_{BBn} and generating the N_{bq} quantization amplitude components aᵢ and coefficients C_{i,n} with C_{i,n}=±1 or 0, according to a mapping table that activate and deactivate the pairs of in-phase and quadrature-phase mapping components; mapping the quantized values, into the N_{bq} in-phase and quadrature-phase mapping components aᵢC_{i,n} cos (αₙ) and a₁C_{i,n} sin (αₙ), respectively; multiplying each in-phase and quadrature-phase component by cos (2πf_{c}t) and sin (2πf_{c}t), or using phase αₙ to set the initial phase of cos (2πf_{c}t) and sin (2πf_{c}t) and multiplying the sinusoidal signals by amplitudes aᵢC_{i,n}; or combining the in phase and quadrature-phase mapping components and generating the corresponding RF bandpass components with the frequency f_{c} for the output signal.

In another exemplary embodiment, the step of receiving the input signal carrying the information can include receiving a baseband signal s_{BB}(t) and sampling it in a sampling circuitry or a sample and hold (S/H) circuitry to generate the samples s_{BBn} of the input signal.

In another exemplary embodiment, the step of receiving the input signal carrying the information can include receiving samples of in-phase s_{l,n}=Aₙ cos (αₙ) and quadrature-phase component s_{Q,n}=Aₙ sin (αₙ) of a baseband signal s_{BB}(t).

In another exemplary embodiment, the method can include computing the remainder Δtᵢ of the division of the sampling instant Δt+nT_{S} by Tᵢ=1/fᵢ, computing the remainder of the division of 2πfᵢΔtᵢ by 2π, computing the remainder Δt_{c} of the division of the sampling instant Δt+nT_{S} by Tc=1/f_{c}, or computing the remainder of the division of 2πf_{c}Δt_{c} by 2π.

In another exemplary embodiment, the steps of quantizing and mapping can further include computing the quantization error e_{q}, quantizing the quantization error e_{q}, to obtain e_{qQ} and applying a weighted compensation of the quantized quantization error e_{qQ} to the mapping components.

In another exemplary embodiment, the method can further include multiplying each pair of in-phase and quadrature-phase mapping components by cos (2πfᵢt) and sin (2πfᵢt), respectively, and combining the pairs of in phase and quadrature-phase components resulting from the previous multiplication to obtain the corresponding bandpass components having an intermediate frequency fᵢ, that can then be up-converted to the RF carrier frequency f_{c}.

In another exemplary embodiment, the method can further include controlling the initial phase of the bandpass signals generated for each sampling interval based on the phase αₙ of each sample.

In another exemplary embodiment, the method can further include a prior processing of the successive samples of the input signal from a data block to compute the set of phases an and amplitudes Aₙ before the quantization step.

In another exemplary embodiment, the steps of quantizing, mapping and generating the bandpass components can be performed in a single step in a digital circuit.

In another exemplary embodiment, the method can further include processing each one of active pairs of in-phase and quadrature-phase mapping components in a quadrature-phase modulator circuitry or DAC circuitry to generate N′ active intermediate frequency bandpass components that are input to N′ mixer circuits operable to up-convert to obtain N′ RF bandpass components, with the quantization error being reduced or canceled on the resulting bandpass components.

In one exemplary embodiment, an apparatus can include an input circuitry operable to receive the time samples s_{BBn}=s_{BB}(tₙ)=s_{l,n}+j s_{Q,n}=Aₙ cos (αₙ)+j Aₙ sin (αₙ)=Aₙ exp (j αₙ), where tₙ denotes a sampling instant, s_{l,n}=Aₙ cos (αₙ), s_{Q,n}=Aₙ sin (αₙ),

$${A}_{n} = \sqrt{{s}_{I , n}^{2} + {s}_{Q , n}^{2}} ,$$

αₙ=ATAN (s_{Q,n}/s_{l,n}) or receive the samples s_{l,n} and s_{Qn} of the in-phase and quadrature-phase components of a baseband signal s_{BB}(t); an input circuitry operable to receive a clock signal having a sampling frequency fₛ=1/T_{S}; an input circuitry operable to receive a clock signal having a certain RF f_{c}; an input circuitry operable to receive a clock having a certain intermediate frequency fᵢ; a bandpass parameters computation circuitry operable to compute, for each sample s_{BBn},

$${A}_{n} = \sqrt{{s}_{I , n}^{2} + {s}_{Q , n}^{2}} ,$$

αₙ=ATAN4 (s_{Q,n}/s_{l,n}) and Δt_{c}=mod (Δt+nT_{S},T_{c}), where T_{c}=1/f_{c}; a quantizer circuitry operable to quantize each sample to obtain the set of N_{bq} quantization bits for that sample and obtain the quantized value A_{qn}=Aₙ+e_{q}, and compute the quantization error e_{q} and the coefficients

$${C}_{i , n} = \{ \begin{matrix}\pm 1 \\ 0\end{matrix} ,$$

that represent the quantized value in terms of the set of discrete amplitudes aᵢ={a₁, a₂, . . . , a_{Nbq}} in which the quantized value can be decomposed, and also quantizes e_{q} into e_{qQ}, based on a LUT circuitry having values that represent N_{q} quantization intervals; a mapper circuitry operable to receive the quantization bits and the quantized quantization error e_{qQ} to obtain a set of N′≤N_{bq} active pairs of in-phase and quadrature-phase quantization components based on the mapping table with quantization bits and the set of amplitudes aᵢ={a₁, a₂, . . . , a_{Nbq}} and the coefficients Cin needed to map the quantized value into N′≤N_{bq} active pairs of in-phase s_{I,i} and quadrature-phase s_{Q,i} mapping components, given by C_{i,n}aᵢ cos (αₙ) and C_{i,n}aᵢ sin (αₙ) and a weighted adding of e_{qQ}; a modulator and mixer circuitry having N_{bq} in-phase and quadrature-phase(I/Q) modulator circuits and mixer circuits operable to receive the pairs of in-phase and quadrature-phase mapping components, the amplitudes aᵢ and the phase αₙ and obtain a set of RF bandpass components, with each bandpass component for the sampling interval Δt+nT_{S}≤tₛ≤Δt+(n+1)T_{S} being given by S_{BPn,i}=S_{BP}(tₛ)=C_{i,n}aᵢ cos (2πf_{c}tₛ+αₙ); or a circuitry with a set of N_{bq} I/Q DACs operable to receive the pairs of in-phase and quadrature-phase components, the amplitudes aᵢ and the phase αₙ, and obtain the set of RF bandpass components, with each RF bandpass component for the sampling interval Δt+nT_{S}≤tₛ≤Δt+(n+1)T_{S} being given by s_{BPn,i}=S_{BP}(tₛ)=C_{i,n}aᵢ cos (2πf_{c}tₛ+αₙ).

In another exemplary embodiment, the apparatus can further include a circuitry having a local oscillator circuitry operable to generate a cosine or sine wave having a certain intermediate frequency fᵢ for input to the set of mixer circuits or a circuitry having a phase shifter circuitry operable to obtain a sine or cosine wave to be input to the set of mixer circuits.

In another exemplary embodiment, the apparatus can be configured to receive the clock reference signal having the certain sampling frequency fₛ, the clock reference signal having the certain RF frequency f_{c}.

In another exemplary embodiment, the apparatus can be configured to receive the reference clock signal having the certain intermediate frequency fᵢ and the clock signal having the certain RF carrier frequency f_{c}.

In another exemplary embodiment, the bandpass parameters circuitry, quantization circuitry or the mapper circuitry can be configured determine time or phase synchronization based on a received clock reference signal having a certain sampling frequency fₛ and a received clock reference signal having a certain RF frequency f_{c}.

In another exemplary embodiment, the apparatus can further include a LUT circuitry configured to store the mapping rule table.

In another exemplary embodiment, the apparatus can further include a LUT circuitry configured to store the combinations of the set of quantization bits, the sets of discrete amplitudes aᵢ, or the set of quantized values.

In another exemplary embodiment, the mapper circuitry can be operable to output the amplitudes aᵢ or the phase αₙ to the I/Q modulator circuitry or to the I/Q DACs, and to control the initial phase of the generated sinusoidal signals by the I/Q modulator circuitry or the I/Q DACs for each sampling interval.

In another exemplary embodiment, the apparatus can further include an oscillator circuitry operable to generate a periodic signal having an intermediate frequency and a mixer circuitry operable to multiply the quantization components by that periodic signal to obtain IF bandpass components.

In another exemplary embodiment, the quantizer circuitry and the mapper circuitry can be operable to compute the quantization error e_{q}, quantize the quantization error e_{q} to obtain the quantized quantization error e_{qQ}, and perform a weighted compensation of the quantized quantization error e_{qQ} on the mapping components.

In another exemplary embodiment, the mapper circuitry can be configured to receive feedback information from the I/Q modulator circuitry. Further, the mapper circuitry can be operable to determine phase or time control information for input to the I/Q modulator circuitry to time or phase align the bandpass components output by the I/Q modulator circuitry.

In another exemplary embodiment, the mapper circuitry can be configured to receive feedback information from the I/Q modulator circuitry. Further, the mapper circuitry can be operable to determine phase or time control information for input to the I/Q modulator circuitry to time or phase align the bandpass components output by the mixer circuitry.

In another exemplary embodiment, the mapper circuitry can be configured to receive feedback information from the DACs and mixer circuitry. Further, the mapper circuitry can be operable to determine phase or time control information for input to the DACs to time or phase align the bandpass components output by the mixer circuitry.

In another exemplary embodiment, the mapper circuitry can be configured to receive feedback information from the DACs. Further, the mapper circuitry can be operable to determine phase or time control information for input to the DACs to time or phase align the bandpass components output by the DACs.

In another exemplary embodiment, a circuitry can be operable to sample the input signal such as a baseband signal s_{BB}(t) to obtain the time samples s_{BBn}.

In another exemplary embodiment, the apparatus can be configured to receive the clock reference signal having the certain intermediate frequency fᵢ and receive the clock signal having the certain RF carrier frequency f_{c}.

In another exemplary embodiment, the apparatus can include a single circuitry operable to determine the phase αₙ and the amplitude Aₙ for each sample, quantize and map into quantization components for input to the set of I/Q modulator circuitry or the set of I/Q DAC circuitry.

In another exemplary embodiment, the mapper circuitry can be operable to receive the quantized quantization error e_{qQ} that is weighted and added to the discrete amplitudes aᵢ of the active pairs of quantization components.

In another exemplary embodiment, the quantization error can be added to a smaller or smallest quantization component or added to a higher or highest quantization component or added to one active quantization component.

In another exemplary embodiment, the set of I/Q modulator circuitry can replace the set of I/Q DACs.

In another exemplary embodiment, the apparatus can be further configured to receive the reference clock signal having the certain intermediate frequency fᵢ.

In another exemplary embodiment, the apparatus can include a local oscillator circuitry operable to generate a sinusoidal reference signal having the certain intermediate frequency for input to the set of I/Q modulator circuitry.

In another exemplary embodiment, the apparatus can be further configured to receive a periodic signal having the certain RF frequency of the carrier for input to the set of mixer circuits operable to up-convert the bandpass components;

In another exemplary embodiment, the mapper circuitry can be configured to receive feedback information from the set of I/Q modulator circuitry and the set of mixer circuitry. Further, the mapper circuitry can be operable to determine phase or time control information for the set of I/Q modulator circuitry to enable the RF bandpass components to be time or phase aligned at the output of the set of mixer circuitry.

In another exemplary embodiment, the apparatus can be further configured to receive the reference clock signal having the certain carrier frequency f_{c}.

In another exemplary embodiment, the apparatus can include a local oscillator circuitry operable to generate a sinusoidal reference signal having the certain intermediate frequency for input to the set of I/Q DACs. Further, the apparatus can be further configured to receive an input clock signal having the certain carrier RF frequency f_{c} for input to a set of mixer circuits operable to up-convert the bandpass components based on the clock signal. In addition, the mapper circuitry can be configured to receive feedback information from the I/Q DACs and the mixer circuitry. Further, the mapper circuitry can be operable to determine phase or time control information for input to the I/Q DACs to time or phase align the RF bandpass components at the output of the mixer circuitry.

In another exemplary embodiment, the apparatus can further include a local oscillator circuitry that generates a sinusoidal reference signal with the intermediate frequency fᵢ to be employed in the set of I/Q DACs.

In another exemplary embodiment, the apparatus can further include a circuitry having a quantizer circuitry and a mapper circuitry operable to process each one of active pairs of in-phase and quadrature-phase mapping components for output to a circuitry having a set of quadrature-phase modulator circuitry or DACs operable to obtain a set of N′ active intermediate frequency bandpass components for input to a set of N′ mixer circuitry operable to up-convert the set of N′ active intermediate frequency bandpass components to obtain a set of N′ RF bandpass components, with the quantization error reduced or canceled on one or more of those IF bandpass components and the corresponding RF bandpass components.

In another exemplary embodiment, the apparatus can further include a circuitry having a quantizer circuitry and a mapper circuitry operable to process each one of the active pairs of in-phase and quadrature-phase mapping components for output to a circuitry having quadrature-phase modulator circuitry or DACs operable to obtain a set of N′ active RF bandpass components having the carrier frequency f_{c}, with the quantization error reduced or canceled on one or more of those RF bandpass components.

In one exemplary embodiment, a method is performed by a user equipment device having a circuitry operationally coupled to a set of power amplifier circuitry operable to collectively amplify an input signal having information. The method includes outputting, by the circuitry, a set of bandpass components that collectively represents a sample of the input signal. Further, the set of bandpass components corresponds to the set of power amplifier circuitry and is associated with a quantized amplitude of a polar representation of the sample.

In another exemplary embodiment, each quantization component is associated with one of a set of quantization bits that represents a quantized amplitude of the polar representation of the sample.

In another exemplary embodiment, at least one power amplifier circuitry is configured to output power that is linearly proportional to another of the set of power amplifier circuitry or at least one power amplifier circuitry is configured to output power that is non-linearly proportional to another of the set of power amplifier circuits.

In another exemplary embodiment, the set of bandpass components includes a certain IF or RF frequency signal.

In another exemplary embodiment, each component corresponds to one of the set of power amplifier circuitry, one of a set of quantization bits that represents a quantized amplitude of the polar representation of the sample, and a phase of the polar representation of the input sample.

In one exemplary embodiment, a user equipment device includes a set of power amplifier circuitry operable to collectively amplify an input signal having information. Further, the user equipment device includes a circuitry electrically coupled to the set of power amplifier circuitry and operable to output a set of bandpass components that collectively represents a sample of the input signal. The set of bandpass components corresponds to the set of power amplifier circuitry and is associated with a quantized amplitude of a polar representation of the sample.

In one exemplary embodiment, a method is performed by a user equipment device having a set of power amplifier circuitry. The method includes amplifying, by the set of power amplifier circuitry, a set of output signals that collectively represents an amplified sample of an input signal having information. Further, the set of output signals is associated with a set of bandpass components that collectively represents a sample of the input signal. In addition, the set of bandpass components corresponds to the set of power amplifier circuitry and is associated with a quantized amplitude of a polar representation of the sample.

In one exemplary embodiment, a user equipment device includes a set of power amplifier circuitry operable to amplify a set of output signals that collectively represents an amplified sample of an input signal having information. Further, the set of output signals is associated with a set of bandpass components that collectively represents a sample of the input signal. In addition, the set of bandpass components correspond to the set of power amplifier circuitry and is associated with a quantized amplitude of a polar representation of the sample.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and FPGAs and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more ASICs, in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a CD or DVD; a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a LAN. Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a user equipment device having a circuitry operationally coupled to a set of power amplifier circuitry operable to collectively amplify an input signal having information; and
outputting, by the circuitry, a set of bandpass components that collectively represents a sample of the input signal, with the set of bandpass components corresponding to the set of power amplifier circuitry and being associated with a quantized amplitude of a polar representation of the sample.

2. The method of claim 1, wherein each quantization component is associated with one of a set of quantization bits that represents a quantized amplitude of the polar representation of the sample.

3. The method of claim 1, wherein at least one power amplifier circuitry is configured to output power that is linearly proportional to another of the set of power amplifier circuitry or at least one power amplifier circuitry is configured to output power that is non-linearly proportional to another of the set of power amplifier circuits.

4. The method of claim 1, wherein the set of bandpass components includes a certain intermediate frequency (IF) or radio frequency (RF) signal.

5. The method of claim 1, wherein each component corresponds to one of the set of power amplifier circuitry, one of a set of quantization bits that represents a quantized amplitude of the polar representation of the sample, and a phase of the polar representation of the input sample.

6. A user equipment device, comprising:
a set of power amplifier circuitry operable to collectively amplify an input signal having information; and
a circuitry electrically coupled to the set of power amplifier circuitry and operable to output a set of bandpass components that collectively represents a sample of the input signal, with the set of bandpass components corresponding to the set of power amplifier circuitry and being associated with a quantized amplitude of a polar representation of the sample.

7. The device of claim 6, wherein each quantization component is associated with one of a set of quantization bits that represents a quantized amplitude of the polar representation of the sample.

8. The device of claim 6, wherein at least one power amplifier circuitry is configured to output power that is linearly proportional to another of the set of power amplifier circuitry or at least one power amplifier circuitry is configured to output power that is non-linearly proportional to another of the set of power amplifier circuits.

9. The device of claim 6, wherein the set of bandpass components includes a certain intermediate frequency (IF) or radio frequency (RF) signal.

10. The device of claim 6, wherein each component corresponds to one of the set of power amplifier circuitry, one of a set of quantization bits that represents a quantized amplitude of the polar representation of the sample, and a phase of the polar representation of the input sample.

11. A method, comprising:
by a user equipment device having a set of power amplifier circuitry; and
amplifying, by the set of power amplifier circuitry, a set of output signals that collectively represents an amplified sample of an input signal having information, with the set of output signals being associated with a set of bandpass components that collectively represents a sample of the input signal, with the set of bandpass components corresponding to the set of power amplifier circuitry and being associated with a quantized amplitude of a polar representation of the sample.

12. The method of claim 11, wherein each output signal is associated with one of a set of quantization bits that represents a quantized amplitude of the polar representation of the sample.

13. The method of claim 11, wherein at least one power amplifier circuitry is configured to output power that is linearly proportional to another of the set of power amplifier circuitry or at least one power amplifier circuitry is configured to output power that is non-linearly proportional to another of the set of power amplifier circuits.

14. The method of claim 11, wherein the set of bandpass components includes a certain IF or RF frequency signal.

15. The method of claim 11, wherein each output signal corresponds to one of the set of power amplifier circuitry, one of a set of quantization bits that represents a quantized amplitude of the polar representation of the sample, and a phase of the polar representation of the input sample.

16. A user equipment device, comprising:
a set of power amplifier circuitry operable to amplify a set of output signals that collectively represents an amplified sample of an input signal having information, with the set of output signals being associated with a set of bandpass components that collectively represents a sample of the input signal, with the set of bandpass components corresponding to the set of power amplifier circuitry and being associated with a quantized amplitude of a polar representation of the sample.

17. The device of claim 16, wherein each output signal is associated with one of a set of quantization bits that represents a quantized amplitude of the polar representation of the sample.

18. The device of claim 16, wherein at least one power amplifier circuitry is configured to output power that is linearly proportional to another of the set of power amplifier circuitry or at least one power amplifier circuitry is configured to output power that is non-linearly proportional to another of the set of power amplifier circuits.

19. The device of claim 16, wherein the set of bandpass components includes a certain intermediate frequency (IF) or radio frequency (RF) signal.

20. The device of claim 16, wherein each output signal corresponds to one of the set of power amplifier circuitry, one of the set of quantization bits that represents the quantized amplitude of the polar representation of the sample, and a phase of the polar representation of the input sample.
